(19) United States
(12) Patent Application Publication
(10) Pub. No.: US 2026/0144286 A1
(43) Pub. Date: May 28, 2026

(54) A MOULDED AEROSOL-GENERATING MATERIAL IN THE FORM OF ONE OR MORE NON-LINEAR STRANDS

(71) Applicant: NICOVENTURES TRADING LIMITED, London (GB)

(72) Inventors: Walid Abi AOUN, London (GB); Stuart MARTIN, London (GB); Fiona ALIU, London (GB); Jana JEFFERY, London (GB); Alejandro PARISI, London (GB); Joanna SOFFE, London (GB)

(21) Appl. No.: 19/121,612

(22) PCT Filed: Oct. 20, 2023
(86) PCT No.: PCT/EP2023/079362

§ 371 Date: Apr. 16, 2025

(30) Foreign Application Priority Data
Oct. 20, 2022 (GB) 2215504.8

(51) Int. Cl. A24D 1/20; A24B 15/16; A24B 15/42; A24F 40/20; H05B 6/10

(52) U.S. Cl. CPC A24D 1/20; A24B 15/16; A24B 15/42; A24F 40/20; H05B 6/108

(57) ABSTRACT

The invention provides a moulded aerosol-generating material in the form of one or more non-linear strands. The invention also provides aerosol-generating compositions comprising the aerosol-generating material, consumables for use within a non-combustible aerosol provision system, and non-combustible aerosol provision systems. The invention also provides methods for producing the aerosol-generating material.

### TECHNICAL FIELD

The present invention relates to aerosol-generating materials, aerosol-generating compositions comprising the aerosol-generating material; consumables for use within a non-combustible aerosol provision system, the consumables comprising the aerosol-generating composition; and non-combustible aerosol provision systems. The invention also relates to methods for producing the aerosol-generating material, and aerosol-generating materials obtainable by the methods of the invention.

### BACKGROUND

Smoking consumables such as cigarettes, cigars and the like burn tobacco during use to create tobacco smoke. Alternatives to these types of consumables release an inhalable aerosol or vapour by releasing compounds from a substrate material by heating without burning. These may be referred to as non-combustible smoking consumables or aerosol generating assemblies.

One example of such a product is a heating device which releases compounds by heating, but not burning, a solid aerosol-generating material. This solid aerosol-generating material may, in some cases, contain a botanical material. The heating volatilises at least one component of the material, typically forming an inhalable aerosol. These products may be referred to as heat-not-burn devices, tobacco heating devices or tobacco heating products. Various different arrangements for volatilising at least one component of the solid aerosol-generating material are known.

As another example, there are hybrid devices. These contain a liquid source (which may or may not contain nicotine) which is vaporised by heating to produce an inhalable vapour or aerosol. The device additionally contains a solid aerosol-generating material (which may or may not contain a tobacco material) and components of this material are entrained in the inhalable vapour or aerosol to produce the inhaled medium.

### SUMMARY

According to a first aspect of the present invention, there is provided a moulded aerosol-generating material in the form of one or more non-linear strands.

In a second aspect, there is provided an aerosol-generating composition comprising the aerosol-generating material of the first aspect.

According to a further aspect of the present invention, there is provided a method of forming an aerosol-generating material in the form of non-linear strands, the method comprising:
(a) forming a mixture comprising a solvent, an aerosol-generating agent, a binder, optionally a filler, optionally a setting agent, and optionally an active and/or a flavourant and/or an acid;
(b) casting the mixture in a mould.

According to a further aspect of the present invention, there is provided a consumable for use within a non-combustible aerosol provision system, the consumable comprising the aerosol-generating composition as defined herein.

According to a further aspect of the present invention, there is provided a non-combustible aerosol provision system comprising the consumable as defined herein and a non-combustible aerosol provision device, the non-combustible aerosol provision device comprising an aerosol-generation device configured to (or arranged to) generate aerosol from the consumable when the consumable is used with the non-combustible aerosol provision device.

According to a further aspect of the invention, there is provided the use of an aerosol-generating composition as defined herein in a consumable for use in a non-combustible aerosol provision device, the non-combustible aerosol provision device comprising an aerosol-generation device arranged to generate aerosol from the consumable when the consumable is used with the non-combustible aerosol provision device.

According to a further aspect of the invention, there is provided the use of an aerosol-generating material or an aerosol-generating composition as defined herein for generating an aerosol.

According to a further aspect, the invention provides an aerosol-generating material obtainable by, or obtained by, a method of the invention.

According to a further aspect of the present invention, there is provided a method of generating an aerosol using a non-combustible aerosol provision system as described herein, the method comprising heating the aerosol-generating material.

In some embodiments, the method comprises heating the aerosol-generating material to a temperature of less than or equal to 350° C. In some embodiments, the method comprises heating the aerosol-generating material to a temperature of from about 220° C. to about 280° C.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a section view of an example of an aerosol-generating article.

FIG. 2 shows a perspective view of the article of FIG. 1.

FIG. 3 shows a sectional elevation of an example of an aerosol-generating article.

FIG. 4 shows a perspective view of the article of FIG. 3.

FIG. 5 shows a perspective view of an example of an aerosol generating assembly.

FIG. 6 shows a section view of an example of an aerosol generating assembly.

FIG. 7 shows a perspective view of an example of an aerosol generating assembly.

FIGS. 8 and 10 show schematic diagrams of the aerosol-generating material of the invention.

FIG. 9 shows a schematic cross-section of the aerosol-generating material of FIG. 8.

FIG. 11 shows a photograph of aerosol-generating material in the form of non-linear strands (left) and an equivalent aerosol-generating material in the form of a shredded sheet (right).

FIG. 12 shows a photograph of aerosol-generating material in the form of non-linear strands.

FIG. 13 shows a photograph of a series of non-linear strands of aerosol-generating material.

FIG. 14 shows a microscope image of a specimen of a single non-linear strand of aerosol-generating material.

### DETAILED DESCRIPTION

The aerosol-generating materials/compositions described herein are materials/compositions that are capable of generating aerosol, for example when heated, irradiated or energized in any other way. The aerosol-generating composition comprises an aerosol-generating material. The aerosol-generating material may be a dried gel. The aerosol-generating material may be a solid material that may retain some fluid, such as liquid, within it.

In some embodiments, the aerosol-generating composition may comprise from about 50 wt %, 60 wt % or 70 wt % of aerosol-generating material, to about 90 wt %, 95 wt % or 100 wt % of aerosol-generating material. In some cases, the aerosol-generating composition consists of the aerosol-generating material. In other cases, the aerosol-generating composition comprises from about 40 to about 60 wt % of the aerosol-generating material. The remainder of the composition may be formed from other components as described below, for example tobacco material.

As described hereinabove, the invention provides a moulded aerosol-generating material in the form of one or more non-linear strands. The aerosol-generating material may comprise an aerosol-generating agent and/or a binder.

The aerosol-generating material may also optionally comprise one or more fillers, a setting or crosslinking agent, an active and/or a flavourant and/or an acid.

The aerosol-generating material is in the form of non-linear strands, which may alternatively be described as non-linear gel fibers. That is, the aerosol-generating material is in the form of strands or gel fibers, wherein each strand or fiber is non-linear across its length. The strands or fibers may alternatively be described as being curly, noodle-like or kinked. Each strand may therefore be thought of as being similar in shape to a noodle, whilst a number of the strands or gel fibers together can be thought of as being similar in shape to a collection of multiple noodles, where the individual strands may overlap and interlink randomly with each other. As used herein, the term “non-linear strands” is also intended to encompass the alternative terms described herein, such as “non-linear gel fibers”, “curly strands”, “curly gel fibers”, “noodle-like strands”, “noodle-like gel fibers”, “kinked strands”, etc.

In some embodiments, the non-linear strands may be arranged to form a net, mesh or mesh-like structure. In some embodiments, the non-linear strands may be joined or woven together, for example to form sheets of aerosol-generating material.

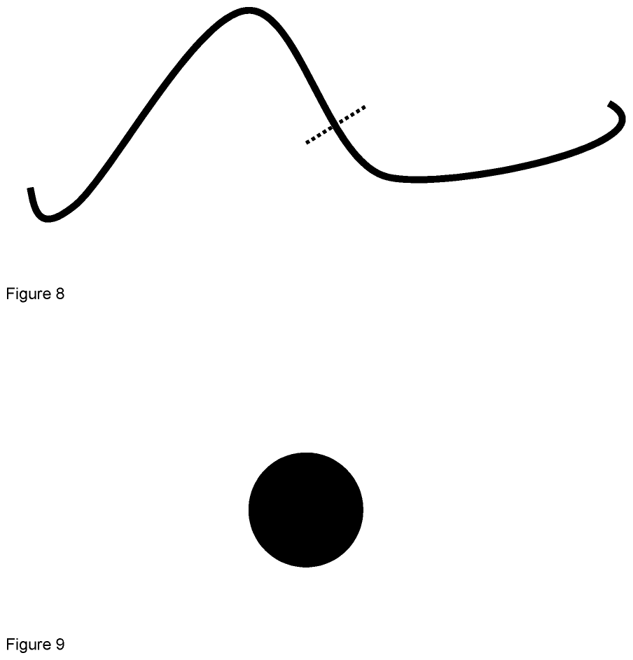

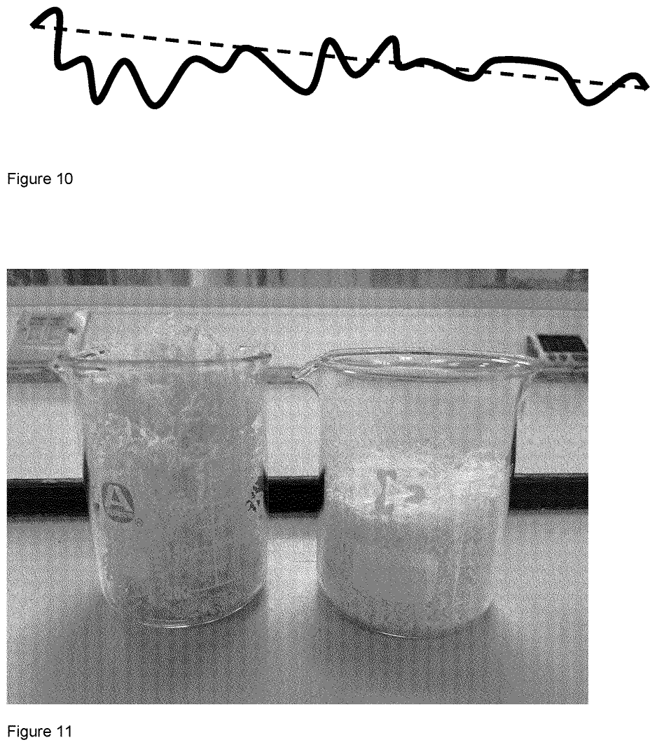

Schematic examples of a non-linear strand of the invention are shown as the solid lines in FIGS. 8 and 10, although it will be appreciated that these figures show a two dimensional representation of a three dimensional structure. In reality, each strand is three dimensional, and may also be non-linear in three dimensions. By “non-linear” in three dimensions it is meant that the stands of the invention are non-linear in the x, y and z directions. A spring or coil is an example of a shape which is non-linear in the x, y and z directions. In contrast, other strands may be non-linear in two dimensions (e.g. the x and y direction), but linear or flat in the third dimension (e.g. the z direction).

Each non-linear strand may have a diameter from about 0.05 mm, 0.1 mm, 0.2 mm, 0.3 mm or 0.5 mm to about 3 mm, 2.5 mm, 2 mm, 1.5 mm, 1.1 mm, 0.8 mm, 0.6 mm or 0.5 mm. In some embodiments, each non-linear strand has a diameter of from about 0.05 mm to about 3 mm, from about 0.3 to about 2.5 mm, from about 0.5 to about 1.5 mm, or from about 0.7 to about 1.1 mm. In some embodiments, each non-linear strand has a diameter of from about 0.1 to about 2 mm, from about 0.1 to about 1.0 mm, or from about 0.2 to about 0.4 mm. The diameter, also referred to as the width, is defined as the longest dimension of the cross-section of the strand.

Each non-linear strand may have a circular or substantially circular cross-section.

The cross-section is the shape exposed by making a straight cut through the strand at right angles to the length at that point. An example of a circular cross-section of a strand is shown in FIG. 9, with the cross-section being taken at the dotted line on the schematic representation of the strand of the invention as shown in FIG. 8.

However, as will be described below, the shape of the strands are determined by the shape of the mould used to form them, and therefore the skilled person would recognise that strands having other cross-sectional shapes (e.g. rectangular, substantially rectangular, triangular or substantially triangular) could also be made.

In some embodiments, the non-linear strands are of the invention are homogenous through the cross-section. That is, in some embodiments the composition of the strands is homogeneous.

Each non-linear strand may have a thickness of from about 0.05 mm, 0.1 mm, 0.2 mm, 0.3 mm or 0.5 mm to about 3 mm, 2.5 mm, 2 mm, 1.5 mm, 1.1 mm, 0.8 mm, 0.6 mm or 0.5 mm. In some embodiments, each non-linear strand has a thickness of from about 0.05 mm to about 3 mm, from about 0.3 to about 2.5 mm, from about 0.5 to about 1.5 mm, or from about 0.7 to about 1.1 mm. In some embodiments, each non-linear strand has a thickness of from about 0.1 to about 2.0 mm, from about 0.1 to about 1.0 mm, or from about 0.2 to about 0.4 mm. As used herein, the term “thickness” is the dimension of the cross-section which is perpendicular to the diameter or width.

When the cross-section of the non-linear strand is a circle, the ratio of the diameter to the thickness of the non-linear strand will be 1. Each non-linear strand may have a diameter to thickness ratio of from about 1:2 to about 2:1, such as from about 3:2 to about 2:3, such as about 1:1.

Each non-linear strand may have an overall length (also referred to herein as the total length) of from about 8 mm, 10 mm, 15 mm, 20 mm or 30 mm to about 200 mm, 100 mm, 75 mm or 50 mm. The overall or total length of each strand is also referred to herein as the uncoiled length, and is defined as the theoretical length if the strand was extended to be straight. For example, the overall length of the strand shown in FIG. 10 is the total length of the strand, i.e. the length of the solid black line if this was straightened out.

In some embodiments, each non-linear strand has an overall length of from about 10 mm to about 200 mm, such as from about 20 mm to about 100 mm, or from about 30 mm to about 50 mm.

Each non-linear strand may have an a free-length of from about 3 mm, 5 mm, 8 mm or 11 mm to about 25 mm, 22 mm, 20 mm or 18 mm. The term “free length” as used herein is intended to mean the shortest (linear) length between the furthest ends of the strand in its natural non-linear (or curly) state (e.g. the distance between the ends of the strand “as the crow flies”). This is also referred to herein as the coiled length. For example, in FIG. 10 the free-length or coiled length of the strand is shown by the dashed line. Non-linear strands with a free-length outside of the ranges disclosed herein may clump together more readily than non-linear strands having a free-length as defined herein.

In some embodiments, each non-linear strand has a free or coiled length of from about 2 mm to about 35 mm, such as from about 3 mm to about 25 mm, from about 6 to about 23 mm, from about 8 mm to about 22 mm, or from about 11 mm to about 20 mm.

The total or uncoiled length is greater than the free or coiled length. In some embodiments, the ratio between the total length and the free length of each non-linear strand (i.e. the total length divided by the free length) is at least about 1.2, such as at least about 1.3, at least about 1.5 or at least about 2. In some embodiments, the ratio between the total length and the free length of each non-linear strand is less than about 10, less than about 8 or less than about 6. In some embodiments, the ratio between the total length and the free length of each non-linear strand is from about 1.2 to about 10, such as from about 1.5 to about 5, or from about 2 to about 5.

In some embodiments, the aspect ratio of the non-linear strands (i.e. the total length divided by the diameter) ranges from about 5 to about 200, such as from about 10 to about 100 or about 20 to about 50.

In some embodiments, the tensile strength of each strand ranges from about 0.1 N, 0.2 N, 0.3 N or 0.4 N to about 3.0 N, 2.0 N, 1.5 N or 1.0 N. In some embodiments, the tensile strength of each strand ranges from about 0.1 N to about 3.0 N, from about 0.2 N to about 2.0 N, or from about 0.3 N to about 1.0 N.

The tensile strength of the non-linear strands of the present invention may be determined by measuring the tensile force needed to break the strand. A suitable test procedure is set out in ISO 527-3:1995. As used herein, the tensile strength is essentially the force needed to break the strand, and is given as a force (in Newtons) per strand. The force needed to break the strand may be determined using an appropriate machine, for example a tensile testing machine from Instron, model 68TM-5. Before measuring the tensile strength, the samples should be conditioned at 22° C.±1° C. and a relative humidity (RH) of (60±2) % for at least 48 hours. The atmospheric pressure should be within the range 96 kPa±10 kPa.

In some embodiments, the uncoiled length, coiled length, aspect ratio and/or tensile strength values of each strand may be calculated as averages of measurements taken for multiple strands. For example, the values may be calculated as averages of measurements taken for from about 5 to about 100 strands, such as from about 20 to about 70 strands, such as 50 strands.

However, because the strands are formed using a mould they may all be identical or substantially identical. In this case properties of the strands such as the uncoiled length, coiled length, aspect ratio and/or tensile strength values may be the same or substantially the same between strands. It may therefore not be necessary to calculate these values as averages, although this can still be done. In some embodiments the uncoiled length, coiled length, aspect ratio and/or tensile strength values may therefore be measured for a single strand. This single strand may then be taken to be representative of all the strands.

In some embodiments, the aerosol-generating material has a fill value of at least about 2 cm³/g, 2.5 cm³/g, 3 cm³/g, 3.5 cm³/g, 4 cm³/g, 4.5 cm³/g, or 5 cm³/g. In some embodiments the fill value is less than about 6 cm³/g, 6.5 cm³/g, 7 cm³/g, 7.5 cm³/g, 8 cm³/g, 8.5 cm³/g, 9 cm³/g, 9.5 cm³/g or 10 cm³/g. In some embodiments, the aerosol-generating material has a fill value from about 2 cm³/g to about 7.5 cm³/g, from about 3 cm³/g to about 7 cm³/g, from about 3.5 cm³/g to about 6 cm³/g or from about 4 cm³/g to about 6 cm³/g. In other embodiments, the aerosol-generating material has a fill value of from about 3 cm³/g to about 10 cm³/g, from about 4 cm³/g to about 9.5 cm³/g, from about 4.5 cm³/g to about 9 cm³/g or from about 5 cm³/g to about 9 cm³/g.

The fill value is measured by placing a known weight of material within a cylinder of known dimensions. It is subjected to pressure from a weighted piston for 30 seconds. The residual height of the compressed sample is measured and converted to volume. The fill value is then calculated as the volume of material over the mass.

In more detail, the fill value of the non-linear strands of the present invention may be determined by the following procedure: a 20 g sample of the material is deposited into a 60 mm diameter cylinder of a densimeter and then the material is compressed with a 2.90±0.03 kg piston for 30 seconds. The height of the piston in the densimeter is measured. The fill values of the samples are calculated according to the following formulae.

The volume occupied by the material when compressed is determined using Formula 1:

$$Volume ( {cm}^{3} ) = π \times {r}^{2} \times \frac{h}{10} \qquad Formula 1$$

r=radius of cylinder (cm)
h=measured height (mm)

The fill value is then determined using the measured volume and mass of material according to Formula 2:

$$Fill value [ {cm}^{3} / g ] = \frac{Volume [ {cm}^{3} ]}{Mass [ g ]} \qquad Formula 2$$

The fill value can also be given in units of cm³/10 g, with 1 cm³/g being equal to 10 cm³/10 g.

The inventors have found that the aerosol-generating material of the present invention has a higher fill value than aerosol-generating materials comprising the same components but which are formed as flat sheets (e.g. by casting on a flat surface), rolled sheets (e.g. by rolling flat sheets), or shredded sheets (e.g. by shredding flat sheets). Filling value (also referred to herein as fill value) is a measure of the volume occupied by a given mass of material when a given pressure is applied. That is, the fill value is a measure of the ability of a material to occupy a specific volume.

By using a higher fill value material as an aerosol-generating material, it may be possible to provide articles and consumables having a lower overall weight than conventional articles. Reducing the overall weight can provide numerous advantages, such as reduced transportation costs as well as reduced material costs and/or taxes. Furthermore, reducing the weight of articles may also have a positive impact on the environment because less energy may be required to transport articles. In addition, consumers may prefer to carry and use a lighter-weight article. The material could also be used as a non-tobacco containing aerosol generating substrate.

The materials of the present invention have a higher fill value than conventional aerosol-generating materials because the packing efficiency of the aerosol-generating material in the form of non-linear strands is lower than conventional aerosol-generating materials, which may be in the form of flat sheets, rolled sheets or shredded sheets. That is, if a container having a given volume were filled with the material of the invention, the percentage of the container which is occupied by material would be lower than for a conventional aerosol-generating material which may be in the form of a flat, rolled or shredded sheet. Put another way, there would be a higher volume of voids or empty space in the container containing the material of the invention. Thus, less aerosol-generating material would be needed to fill the container.

It is therefore advantageous to be able to form materials having a similar chemical composition to conventional aerosol-generating materials, but which are in the form described herein, such that they have a higher fill value.

FIG. 11 shows an image of the same weight of an aerosol-generating material in the form of strands (left), compared to a similar material which is formed as a flat sheet and then shredded (right).

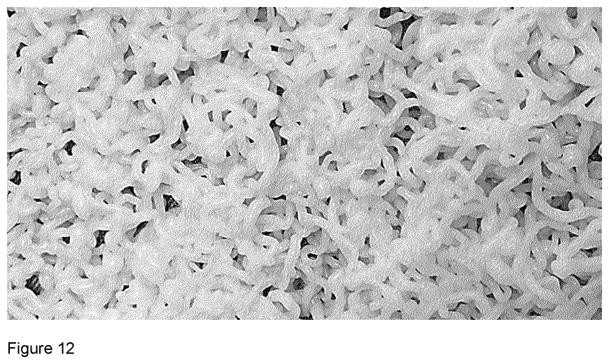

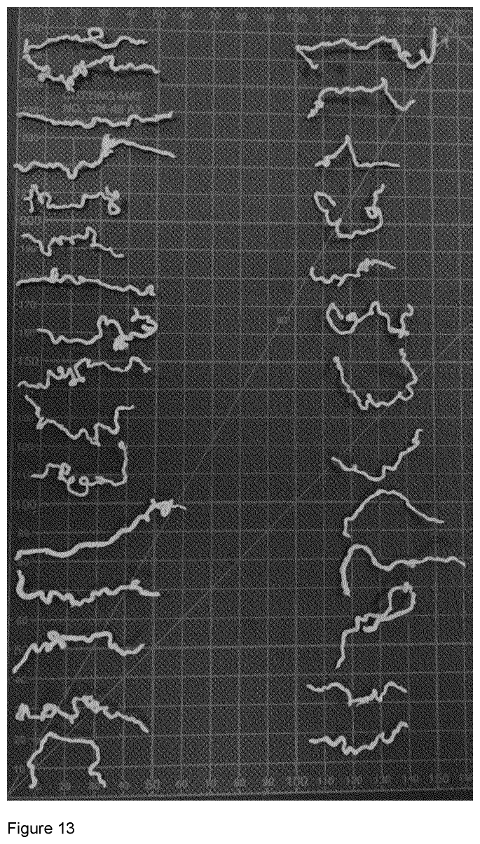

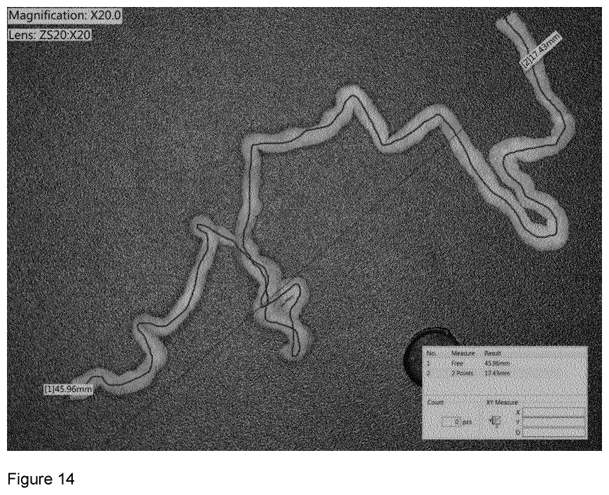

FIG. 12 shows a photograph of an aerosol-generating material in the form of a number of non-linear strands.

The aerosol-generating material may comprise about 1 wt %, 3 wt %, 5 wt %, 10 wt %, 15 wt %, or 20 wt % to about 80 wt %, 60 wt %, 50 wt %, 40 wt % or 30 wt % of aerosol-generating agent (all calculated on a dry weight basis). In exemplary embodiments, the aerosol-generating material comprises 1-80 wt %, 5-60 wt %, or 10-50 wt % of aerosol-generating agent (all calculated on a dry weight basis). In other embodiments, the aerosol-generating material comprises 10-45 wt %, 20-40 wt % or 30-40 wt % of aerosol-generating agent (all calculated on a dry weight basis). In other embodiments, the aerosol-generating material comprises 10-45 wt %, 10-40 wt % or 15-30 wt % of aerosol-generating agent (all calculated on a dry weight basis). These amounts represent the total amount of aerosol-generating agent(s) in the aerosol-generating material.

In some embodiments, the aerosol-generating agent may comprise one or more of glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate. In some cases, the aerosol-generating agent comprises, consists essentially of or consists of glycerol.

The aerosol-generating material may comprise an amount of about 1 wt %, 5 wt %, 6 wt %, 7 wt %, 10 wt %, or 15 wt % to about 20 wt %, 25 wt %, 30 wt %, 40 wt %, 50 wt % or 60 wt % of binder (all calculated on a dry weight basis). For example, the aerosol-generating material may comprise an amount of 1-60 wt %, 5-50 wt %, 6-40 wt %, 7-20 wt % or 15-25 wt % of binder (dry weight basis). These amounts represent the total amount of binder(s) in the aerosol-generating material.

In some embodiments, the binder comprises (or is) one or more compounds selected from polysaccharide binders, such as alginate, pectin, starch or a derivative thereof, cellulose or a derivative thereof, pullulan, carrageenan, agar and agarose; gelatin; gums, such as gellan gum, xanthan gum, guar gum and acacia gum; silica or silicone compounds, such as PDMS and sodium silicate; clays, such as kaolin; and polyvinyl alcohol.

In some embodiments, the binder comprises alginate, pectin, starch or a derivative thereof, cellulose or a derivative thereof (e.g. carboxymethylcellulose), carrageenan (e.g. iota carrageenan) or gellan gum (e.g. high acyl gellan gum).

The binder may comprise a cellulosic binder and/or a non-cellulosic binder.

Examples of cellulosic binders (i.e. cellulose derivatives) which may be used include, but are not limited to, hydroxymethyl cellulose, hydroxyethyl cellulose, hydroxypropyl cellulose, carboxymethylcellulose (CMC), hydroxypropyl methylcellulose (HPMC), methyl cellulose, ethyl cellulose, cellulose acetate (CA), cellulose acetate butyrate (CAB), and cellulose acetate propionate (CAP).

Examples of non-cellulosic binders which may be used include alginates, pectins, starches (and derivatives), carrageenan (e.g. iota carrageenan), gums (e.g. high acyl gellan gum), silica or silicones compounds, clays, polyvinyl alcohol and combinations thereof.

In some embodiments, the binder is selected from the group consisting of alginates, pectins, pullulan, xanthan gum, guar gum, carrageenan (e.g. iota carrageenan), agarose, acacia gum, gellan gum (e.g. high acyl gellan gum), fumed silica, PDMS, sodium silicate, kaolin and polyvinyl alcohol.

In some embodiments, the binder comprises or consists of alginate, pectin, carrageenan, (e.g. iota-carrageenan), gellan gum (e.g. high acyl gellan gum), a cellulose derivative (e.g. CMC) and combinations thereof.

In some embodiments, the binder comprises or consists of alginate, pectin, carrageenan, (e.g. iota-carrageenan), gellan gum (e.g. high acyl gellan gum) and combinations thereof.

In some embodiments, the binder comprises or consists of a cellulose derivative such as CMC.

In some embodiments, the binder comprises alginate and/or pectin and/or iota-carrageenan.

In some embodiments, the binder comprises alginate and/or iota-carrageenan.

In some embodiments, the binder comprises, consists essentially of, or consists of alginate and pectin.

In some embodiments, the binder comprises, consists essentially of, or consists of alginate and iota-carrageenan.

In some embodiments, the binder does not comprise alginate.

In some embodiments, the binder comprises, consists essentially of, or consists of iota-carrageenan.

The aerosol-generating material may be substantially free of cellulosic binder. “Substantially free” means that material comprises less than 1 wt %, such as less than 0.5 wt % of the relevant component (dry weight basis). In some embodiments, the aerosol-generating material does not comprise a cellulosic binder.

The aerosol-generating material may be substantially free of carboxymethylcellulose (CMC). In some embodiments, the aerosol-generating material does not comprise CMC.

In some embodiments alginate is the only binder present in the aerosol-generating material. In other embodiments the binder comprises alginate and at least one further cellulosic binder (e.g. CMC) or non-cellulosic binder (e.g. pectin or iota carrageenan).

The binder may be crosslinked or non-crosslinked. Generally, cellulosic binders (e.g. CMC) are non-crosslinked. Crosslinked (or crosslinkable) binders include alginate, pectin, carrageenan and gellan gum.

In some embodiments, the aerosol-generating material comprises a crosslinked binder and a non-crosslinked binder.

In some embodiments, the aerosol-generating material does not comprise a crosslinked binder.

In some embodiments, particularly where the binder is a crosslinkable binder (such as alginate, pectin, carrageenan or gellan gum), the aerosol-generating material comprises a crosslinking agent. In some cases, the crosslinking agent comprises calcium ions. In some embodiments, the crosslinking agent comprises calcium lactate, calcium formate, and/or calcium acetate. In some embodiments, the crosslinking agent comprises calcium lactate. In some cases, the aerosol-generating material comprises a calcium-crosslinked alginate. The crosslinking agent may also be described as a setting agent.

The aerosol-generating material may comprise about 0.5 wt %, 1 wt %, 3 wt % or 5 wt % to about 10 wt %, 9 wt %, 8 wt % or 7 wt % of crosslinking agent (all calculated on a dry weight basis). For example, the aerosol-generating material may comprise 1-10 wt %, 3-8 wt % or 5-7 wt % of crosslinking agent (dry weight basis). These amounts represent the total amount of crosslinking agent(s) in the aerosol-generating material.

The aerosol-generating material may comprise about 1 wt %, 10 wt % or 20 wt % to about 80 wt %, 60 wt % or 50 wt % of flavour (all calculated on a dry weight basis). For example, the aerosol-generating material may comprise 1-80 wt %, 10-60 wt %, or 20-50 wt % of flavour. These amounts represent the total amount of flavour(s) in the aerosol-generating material, if a flavour is present.

As used herein, the terms “flavour” and “flavourant” refer to materials which, where local regulations permit, may be used to create a desired taste, aroma, or other somatosensorial sensation in a product for adult consumers. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavour comprises menthol, spearmint and/or peppermint. In some embodiments, the flavour comprises, consists essentially of or consists of menthol.

In some embodiments the flavourant is a water-soluble flavourant.

The flavourant may be incorporated during the formation of the aerosol-generating material (e.g. when forming a slurry comprising the materials that form the aerosol-generating material) or it may be applied to the aerosol-generating material after its formation (e.g. by spraying it onto the aerosol-generating material after drying).

In some embodiments, the aerosol-generating material comprises from about 1 wt %, 5 wt %, 10 wt %, 18 wt % or 20 wt % to about 80 wt %, 70 wt %, 60 wt %, 50 wt %, 45 wt %, 40 wt %, 35 wt % or 30 wt % of filler (all calculated on a dry weight basis). For example, the aerosol-generating material may comprise 1-60 wt %, 1-50 wt %. 5-45 wt %, 10-40 wt %, 18-35 wt % or 20-30 wt % of filler (all calculated on a dry weight basis). In other embodiments, the aerosol-generating material may comprise 10-80 wt %, 20-70 wt %, 30-65 wt % or 40-65 wt % of filler (all calculated on a dry weight basis). These amounts represent the total amount of filler(s) in the aerosol-generating material.

In some embodiments, the aerosol-generating material comprises less than 70 wt. % filler, such as less than 60 wt. % filler, less than 50 wt. %, less than 30 wt. %, less than 20 wt. % or less than 10 wt. %. In some embodiments the aerosol-generating material is substantially free or complete free of filler.

The filler may comprise one or more inorganic filler materials, such as calcium carbonate, perlite, vermiculite, diatomaceous earth, colloidal silica, magnesium oxide, magnesium sulphate, magnesium carbonate, and suitable inorganic sorbents, such as molecular sieves. The filler may comprise one or more organic filler materials such as wood pulp, cellulose and cellulose derivatives (e.g. ground cellulose). In particular cases, aerosol-generating material comprises less than 10 wt %, less than 5 wt %, less than 1 wt % or no calcium carbonate such as chalk. It may be desirable to avoid including high amounts of calcium carbonate (e.g. more than 10 wt %, more than 25 wt % or more than 50 wt %) in the material because calcium carbonate has a high density. As such, including high amounts of calcium carbonate can cause the material to become dense and/or have a low fill value and/or may delay aerosol release.

In particular embodiments the filler is fibrous. For example, the filler may be a fibrous organic filler material such as wood pulp, hemp fibre, cellulose or cellulose derivatives, such as microcrystalline cellulose (MCC), nanocrystalline cellulose and/or ground cellulose. Without wishing to be bound by theory, it is believed that including fibrous filler in an aerosol-generating material may increase the tensile strength of the material.

In some cases, the filler comprises wood pulp, MCC and/or ground cellulose.

In some cases, the filler comprises (or is) wood pulp.

In some cases, the filler comprises maltodextrin or microcrystalline cellulose (MCC). As would be well understood by the skilled person, microcrystalline cellulose may be formed by depolymerising cellulose by a chemical process (e.g. using an acid or enzyme). One example method for forming microcrystalline cellulose involves acid hydrolysis of cellulose, using an acid such as HCl. The cellulose produced after this treatment is crystalline (i.e. no amorphous regions remain). Suitable methods and conditions for forming microcrystalline cellulose are well-known in the art.

In some cases, the filler has a density of less than about 2 g/cm³, such as less than about 0.5 g/cm³ or less than about 0.3 g/cm³.

The aerosol-generating material may have any suitable water content, such as from 1 wt % to 15 wt %. Suitably, the water content of the aerosol-generating material may be from about 5 wt %, 7 wt % or 9 wt % to about 15 wt %, 13 wt %, 11 wt %, 9 wt % or 8 wt % (wet weight basis) (WWB). In some embodiments, the aerosol-generating material has a water content of less than about 9 wt % (WWB), such as less than about 8 wt % (WWB). The water content of the aerosol-generating material may, for example, be determined by Karl-Fischer-titration or Gas Chromatography with Thermal Conductivity Detector (GC-TCD).

Amounts of constituents of the aerosol-generating material, such as aerosol-generating agent (e.g. glycerol) and flavourant (e.g. menthol), can be determined by gas chromatography with a flame ionisation detector (GC-FID).

The aerosol-generating material may comprise a colourant. The addition of a colourant may alter the visual appearance of the aerosol-generating material. The presence of colourant in the aerosol-generating material may enhance the visual appearance of the aerosol-generating material and the aerosol-generating composition. By adding a colourant to the aerosol-generating material, the aerosol-generating material may be colour-matched to other components of the aerosol-generating composition or to other components of an article comprising the aerosol-generating material.

A variety of colourants may be used depending on the desired colour of the aerosol-generating material. The colour of aerosol-generating material may be, for example, white, green, red, purple, blue, brown or black. Other colours are also envisaged. Natural or synthetic colourants, such as natural or synthetic dyes, food-grade colourants and pharmaceutical-grade colourants may be used. In certain embodiments, the colourant is caramel, which may confer the aerosol-generating material with a brown appearance. In such embodiments, the colour of the aerosol-generating material may be similar to the colour of other components (such as tobacco material) in an aerosol-generating composition comprising the aerosol-generating material. In some embodiments, the addition of a colourant to the aerosol-generating material renders it visually indistinguishable from other components in the aerosol-generating composition.

The colourant may be incorporated during the formation of the aerosol-generating material (e.g. when forming a slurry comprising the materials that form the aerosol-generating material) or it may be applied to the aerosol-generating material after its formation (e.g. by spraying it onto the aerosol-generating material).

In some embodiments, (brown) wood pulp is present as a filler, and a colourant may therefore be unnecessary.

In some embodiments, the aerosol-generating composition additionally comprises an active substance, such that the aerosol-generating composition comprises the aerosol-generating material and an active substance. For example, in some cases, the aerosol-generating composition additionally comprises a tobacco material and/or nicotine. In some cases, the aerosol-generating composition may comprise 5-60 wt % (calculated on a dry weight basis) of a tobacco material and/or nicotine. In some cases, the aerosol-generating composition may comprise from about 1 wt %, 5 wt %, 10 wt %, 15 wt %, 20 wt % or 25 wt % to about 70 wt %, 60 wt %, 50 wt %, 45 wt %, 40 wt %, 35 wt %, or 30 wt % (calculated on a dry weight basis) of an active substance.

In some cases, the aerosol-generating composition may comprise from about 1 wt %, 5 wt %, 10 wt %, 15 wt %, 20 wt % or 25 wt % to about 70 wt %, 60 wt %, 50 wt %, 45 wt %, 40 wt %, 35 wt %, or 30 wt % (calculated on a dry weight basis) of a tobacco material. For example, the aerosol-generating composition may comprise 10-50 wt %, 15-40 wt % or 20-35 wt % of a tobacco material. In some cases, the aerosol-generating composition may comprise from about 1 wt %, 2 wt %, 3 wt % or 4 wt % to about 20 wt %, 18 wt %, 15 wt % or 12 wt % (calculated on a dry weight basis) of nicotine. For example, the aerosol-generating composition may comprise 1-20 wt %, 2-18 wt % or 3-12 wt % of nicotine.

In some cases, the aerosol-generating material may comprise a botanical extract. The aerosol-generating material may comprise about 1 wt %, 3 wt %, 5 wt %, 10 wt %, 15 wt %, 20 wt %, 30 wt %, 35 wt % or 40 wt % to about to 30 wt %, 35 wt %, 40 wt %, 50 wt %, 60 wt %, 65 wt % or 70 wt % of botanical extract (all calculated on a dry weight basis). In exemplary embodiments, the aerosol-generating material comprises 1-70 wt %, 5-60 wt %, or 10-50 wt % of botanical extract (all calculated on a dry weight basis). In other embodiments, the aerosol-generating material may comprise 10-40 wt %, 10-35 wt %, 15-30 wt % of botanical extract (all calculated on a dry weight basis). In other embodiments, the aerosol-generating material may comprise 10-70 wt %, 20-65 wt %, 40-60 wt % of botanical extract (all calculated on a dry weight basis). These amounts represent the total amount of botanical extract(s) in the aerosol-generating material.

The botanical extract may comprise or consist of a botanical extract which naturally contains metal (e.g. calcium or magnesium) ions (i.e. the ions are present without being added). In some embodiments, the botanical extract naturally contains calcium ions. The botanical extract may also be described as a plant extract.

As used herein, the term “botanical extract” includes an extract of any material derived from plants including, but not limited to, extracts, leaves, bark, fibres, stems, roots, seeds, flowers, fruits, pollen, husk, shells or the like. Alternatively, the botanical extract may comprise an active compound naturally existing in a botanical, obtained synthetically. Example botanicals are tobacco, eucalyptus, star anise, hemp, cocoa, cannabis, fennel, lemongrass, peppermint, spearmint, rooibos, chamomile, flax, ginger, Ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha arventis, Mentha c.v., Mentha niliaca, Mentha piperita, Mentha piperita citrata c.v., Mentha piperita c.v, Mentha spicata crispa, Mentha cardifolia, Mentha longifolia, Mentha suaveolens variegata, Mentha pulegium, Mentha spicata c.v. and Mentha suaveolens.

In some embodiments, the botanical extract comprises a tobacco extract. In some embodiments, the botanical extract consists essentially of or consists of a tobacco extract. That is, in some embodiments the botanical extract is a tobacco extract.

In some embodiments, the aerosol-generating material comprises a particulate botanical material. The aerosol-generating material may comprise about 1 wt %, 3 wt %, 5 wt %, 10 wt %, 15 wt %, 20 wt %, 30 wt %, 35 wt % or 40 wt % to about to 30 wt %, 35 wt %, 40 wt %, 50 wt %, 60 wt %, 65 wt % or 70 wt % of particulate botanical material (all calculated on a dry weight basis). In exemplary embodiments, the aerosol-generating material comprises 1-70 wt %, 5-60 wt %, 10-50 wt %, or 30-40 wt % of particulate botanical material (all calculated on a dry weight basis).

In some embodiments, the particulate botanical comprises or is particulate tobacco material.

In some embodiments, the aerosol-generating material comprises an additional active other than a botanical extract. In some embodiments, the active comprises nicotine. In some embodiments, the active substance comprises caffeine, melatonin or vitamin B12.

In some embodiments, the active substance may comprise one or more constituents, derivatives or extracts of cannabis, such as one or more cannabinoids or terpenes.

Cannabinoids are a class of natural or synthetic chemical compounds which act on cannabinoid receptors (i.e., CB1 and CB2) in cells that repress neurotransmitter release in the brain. Cannabinoids may be naturally occurring (phytocannabinoids) from plants such as cannabis, from animals (endocannabinoids), or artificially manufactured (synthetic cannabinoids). Cannabis species express at least 85 different phytocannabinoids, and are divided into subclasses, including cannabigerols, cannabichromenes, cannabidiols, tetrahydrocannabinols, cannabinols and cannabinodiols, and other cannabinoids. Cannabinoids found in cannabis include, without limitation: cannabigerol (CBG), cannabichromene (CBC), cannabidiol (CBD), tetrahydrocannabinol (THC), cannabinol (CBN), cannabinodiol (CBDL), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannabinerolic acid, cannabidiolic acid (CBDA), Cannabinol propyl variant (CBNV), cannabitriol (CBO), tetrahydrocannabmolic acid (THCA), and tetrahydrocannabivarinic acid (THCV A).

In some embodiments, the active substance may comprise a cannabinoid, such as cannabidiol (CBD).

In some cases, the aerosol-generating composition comprises an active substance such as tobacco extract. In some cases, the aerosol-generating composition may comprise 5-60 wt % (calculated on a dry weight basis) of tobacco extract. In some cases, the aerosol-generating composition may comprise from about 5 wt %, 10 wt %, 15 wt %, 20 wt % or 25 wt % to about 60 wt %, 50 wt %, 45 wt %, 40 wt %, 35 wt %, or 30 wt % (calculated on a dry weight basis) tobacco extract. For example, the aerosol-generating composition may comprise 10-50 wt %, 15-40 wt % or 20-35 wt % of tobacco extract. The tobacco extract may contain nicotine at a concentration such that the aerosol-generating composition comprises 1 wt % 1.5 wt %, 2 wt % or 2.5 wt % to about 10 wt %, 8 wt %, 6 wt %, 5 wt %, 4.5 wt % or 4 wt % (calculated on a dry weight basis) of nicotine. In some embodiments, the aerosol-generating composition may comprise 1-10 wt %, 2.5-8 wt % or 2-6 wt % nicotine. In some cases, there may be no nicotine in the aerosol-generating composition other than that which results from the tobacco extract.

In some embodiments, the aerosol-generating composition comprises the aerosol-generating material defined herein and a second aerosol-generating material, which may be tobacco. Thus, in some embodiments, the aerosol-generating composition comprises the aerosol-generating material defined herein and tobacco.

In some embodiments, the aerosol-generating material may be shredded and then mixed with tobacco, such as cut-rag tobacco. In another embodiment, the aerosol-generating composition may be in the form of a shredded composition, where the aerosol-generating material and the tobacco are both shredded and mixed together.

In some embodiments, the aerosol-generating composition may comprise from about 5 wt %, 10 wt %, 15 wt % or 20 wt % to about 35 wt %, 40 wt %, 45 wt % or 50 wt % aerosol-generating material. For example, the aerosol-generating composition may comprise from about 10 to about 50 wt % of the aerosol-generating material of the invention, such as from about 20 to about 40 wt %. The remainder of the aerosol-generating composition may comprise tobacco, optionally in combination with a flavourant and/or an acid.

The aerosol-generating composition may comprise from about 10 to about 50 wt % aerosol-generating material and from about 50 to about 90 wt % tobacco, or from about 20 to about 40 wt % aerosol-generating material and from about 60 to about 80 wt % tobacco.

In some embodiments the tobacco comprises (or is) dry ice expanded tobacco (DIET). In some embodiments the aerosol-generating composition comprises a mixture of the aerosol-generating material of the invention and DIET, optionally in combination with other tobacco (e.g. cut rag tobacco).

DIET is known to have a very high filling value (generally above 7 cm³/g), and is sometimes used to reduce the weight of an article or consumable for use in an aerosol provision system. However, it is also known to have a poor flavour profile. The presently claimed aerosol-generating material may therefore offer an improved alternative to DIET, because it has a high fill value but an improved taste profile. It may also be possible to combine DIET with the aerosol-generating material of the invention, thereby reducing the amount of DIET needed to achieve the desired fill value.

In some embodiments, the aerosol-generating composition comprises no tobacco material but does comprise nicotine. In some such cases, the aerosol-generating composition may comprise from about 1 wt %, 2 wt %, 3 wt % or 4 wt % to about 20 wt %, 18 wt %, 15 wt % or 12 wt % (calculated on a dry weight basis) of nicotine. For example, the aerosol-generating composition may comprise 1-20 wt %, 2-18 wt % or 3-12 wt % of nicotine.

The fill value of the aerosol-generating composition may be determined by the fill value of the aerosol-generating material, the fill value of any other material in the composition (e.g. tobacco), and the relative proportions of the materials in the composition. The fill value of a composition may therefore be estimated. For example, a composition comprising 20 wt % of an aerosol-generating material of the invention having a fill value of 7 cm³/g and 80 wt % of tobacco having a fill value of 5 cm³/g would be expected to have a fill value of around 5.4 cm³/g ([7*0.2]+[5*0.8]=5.4).

In some embodiments, the aerosol-generating composition has a fill value of at least about 2 cm³/g, 2.5 cm³/g, 3 cm³/g, 3.5 cm³/g, 4 cm³/g, 4.5 cm³/g, or 5 cm³/g. In some embodiments the fill value is less than about 6 cm³/g, 6.5 cm³/g, 7 cm³/g, 7.5 cm³/g, 8 cm³/g, 8.5 cm³/g, 9 cm³/g, 9.5 cm³/g or 10 cm³/g. In some embodiments, the aerosol-generating composition has a fill value from about 2 cm³/g to about 7.5 cm³/g, from about 3 cm³/g to about 7 cm³/g, from about 3.5 cm³/g to about 6 cm³/g from about 4 cm³/g to about 6 cm³/g or from about 5 cm³/g to about 6 cm³/g. In other embodiments, the aerosol-generating composition has a fill value of from about 3 cm³/g to about 10 cm³/g, from about 4 cm³/g to about 9.5 cm³/g, from about 4.5 cm³/g to about 9 cm³/g or from about 5 cm³/g to about 9 cm³/g.

The aerosol-generating material and/or the aerosol-generating composition may comprise an acid. The acid may be an organic acid. In some of these embodiments, the acid may be at least one of a monoprotic acid, a diprotic acid and a triprotic acid. In some such embodiments, the acid may contain at least one carboxyl functional group. In some such embodiments, the acid may be at least one of an alpha-hydroxy acid, carboxylic acid, dicarboxylic acid, tricarboxylic acid and keto acid. In some such embodiments, the acid may be an alpha-keto acid.

In some such embodiments, the acid may be at least one of succinic acid, lactic acid, benzoic acid, citric acid, tartaric acid, fumaric acid, levulinic acid, acetic acid, malic acid, formic acid, sorbic acid, benzoic acid, propanoic and pyruvic acid.

Suitably the acid is lactic acid. In other embodiments, the acid is benzoic acid. In other embodiments the acid may be an inorganic acid. In some of these embodiments the acid may be a mineral acid. In some such embodiments, the acid may be at least one of sulphuric acid, hydrochloric acid, boric acid and phosphoric acid. In some embodiments, the acid is levulinic acid and/or pyruvic acid.

In some embodiments, the acid is selected from lactic acid, benzoic acid and levulinic acid.

Inclusion of an acid is particularly preferred in embodiments in which the aerosol-generating composition comprises nicotine. The presence of the acid may reduce or substantially prevent evaporation of nicotine during drying of the slurry, thereby reducing loss of nicotine during manufacturing. The presence of the acid may also improve the flavour and impact of the aerosol when nicotine is present. For example, the perceived harshness of the nicotine may be reduced by the presence of the acid.

In some embodiments, the aerosol-generating material is substantially free from tobacco. By “substantially free from” it is meant that the material comprises less than 1 wt %, such as less than 0.5 wt % tobacco (dry weight basis). In some embodiments, the aerosol-generating material is free from tobacco. In some embodiments, the aerosol-generating material does not comprise tobacco fibres. In particular embodiments, the aerosol-generating material does not comprise fibrous material.

In some embodiments, the aerosol-generating composition does not comprise tobacco fibres. In particular embodiments, the aerosol-generating composition does not comprise fibrous material.

In some embodiments, the aerosol-generating article does not comprise tobacco fibres. In particular embodiments, the aerosol-generating article does not comprise fibrous material.

The aerosol-generating material may be made from a gel, and this gel may additionally comprise a solvent, included at 0.1-50 wt %. However, the inclusion of a solvent in which the flavour is soluble may reduce the gel stability and the flavour may crystallise out of the gel. As such, in some cases, the gel does not include a solvent in which the flavour is soluble.

An aspect of the present invention relates to an article (also referred to herein as a consumable). A consumable is an article, part or all of which is intended to be consumed during use by a user. A consumable may comprise or consist of aerosol-generating composition. A consumable may comprise one or more other elements, such as a filter or an aerosol modifying substance. A consumable may comprise a heating element that emits heat to cause the aerosol-generating composition to generate aerosol in use. The heating element may, for example, comprise combustible material, or may comprise a susceptor that is heatable by penetration with a varying magnetic field.

Articles of the present invention may be provided in any suitable shape. In some examples, the article is provided as a rod (e.g. substantially cylindrical). An article provided as a rod may include the aerosol-generating composition, optionally blended with cut tobacco.

A susceptor is material that is heatable by penetration with a varying magnetic field, such as an alternating magnetic field. The heating material may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The heating material may be both electrically-conductive and magnetic, so that the heating material is heatable by both heating mechanisms.

Induction heating is a process in which an electrically-conductive object is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating.

In some embodiments, the susceptor is in the form of a closed circuit. It has been found that, when the susceptor is in the form of a closed circuit, magnetic coupling between the susceptor and the electromagnet in use is enhanced, which results in greater or improved Joule heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule heating.

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object. Moreover, as induction heating and magnetic hysteresis heating do not require a physical connection to be provided between the source of the varying magnetic field and the object, design freedom and control over the heating profile may be greater, and cost may be lower.

An aspect of the invention provides non-combustible aerosol provision system comprising an article according as described herein and non-combustible aerosol provision device comprising a heater which is configured to heat not burn the aerosol-generating article. A non-combustible aerosol provision system may also be referred to as an aerosol generating assembly. A non-combustible aerosol provision device may be referred to as an aerosol generating apparatus.

In some cases, in use, the heater may heat, without burning, the aerosol-generating material to a temperature equal to or less than 350° C., such as between 120° C. and 350° C. In some cases, the heater may heat, without burning, the aerosol-generating composition to between 140° C. and 250° C. in use, or between 220° C. and 280° C. In some cases in use, substantially all of the aerosol-generating material is less than about 4 mm, 3 mm, 2 mm or 1 mm from the heater. In some cases, the material is disposed between about 0.010 mm and 2.0 mm from the heater, suitably between about 0.02 mm and 1.0 mm, suitably 0.1 mm to 0.5 mm. In some cases, a surface of the aerosol-generating material may directly abut the heater.

The heater is configured to heat not burn the aerosol-generating article, and thus the aerosol-generating composition. The heater may be, in some cases, a thin film, electrically resistive heater. In other cases, the heater may comprise an induction heater or the like. The heater may be a combustible heat source or a chemical heat source which undergoes an exothermic reaction to product heat in use. The aerosol generating assembly may comprise a plurality of heaters. The heater(s) may be powered by a battery.

The aerosol-generating article may additionally comprise a cooling element and/or a filter. The cooling element, if present, may act or function to cool gaseous or aerosol components. In some cases, it may act to cool gaseous components such that they condense to form an aerosol. It may also act to space the very hot parts of the non-combustible aerosol provision device from the user. The filter, if present, may comprise any suitable filter known in the art such as a cellulose acetate plug.

In some cases, the aerosol generating assembly may be a heat-not-burn device. That is, it may contain a solid aerosol-generating material (and no liquid aerosol-generating material). In some cases, the aerosol-generating material may comprise the tobacco material. A heat-not-burn device is disclosed in WO 2015/062983 A2, which is incorporated by reference in its entirety.

In some cases, the aerosol generating assembly may be an electronic tobacco hybrid device. An electronic tobacco hybrid device is disclosed in WO 2016/135331 A1, which is incorporated by reference in its entirety.

The aerosol-generating article (which may be referred to herein as an article, a cartridge or a consumable) may be adapted for use in a THP, an electronic tobacco hybrid device or another aerosol generating device. In some cases, the article may additionally comprise a filter and/or cooling element (which have been described above). In some cases, the aerosol-generating article may be circumscribed by a wrapping material such as paper.

The aerosol-generating article may additionally comprise ventilation apertures. These may be provided in the sidewall of the article. In some cases, the ventilation apertures may be provided in the filter and/or cooling element. These apertures may allow cool air to be drawn into the article during use, which can mix with the heated volatilised components thereby cooling the aerosol.

The ventilation enhances the generation of visible heated volatilised components from the article when it is heated in use. The heated volatilised components are made visible by the process of cooling the heated volatilised components such that supersaturation of the heated volatilised components occurs. The heated volatilised components then undergo droplet formation, otherwise known as nucleation, and eventually the size of the aerosol particles of the heated volatilised components increases by further condensation of the heated volatilised components and by coagulation of newly formed droplets from the heated volatilised components.

In some cases, the ratio of the cool air to the sum of the heated volatilised components and the cool air, known as the ventilation ratio, is at least 15%. A ventilation ratio of 15% enables the heated volatilised components to be made visible by the method described above. The visibility of the heated volatilised components enables the user to identify that the volatilised components have been generated and adds to the sensory experience of the smoking experience.

In another example, the ventilation ratio is between 50% and 85% to provide additional cooling to the heated volatilised components. In some cases, the ventilation ratio may be at least 60% or 65%.

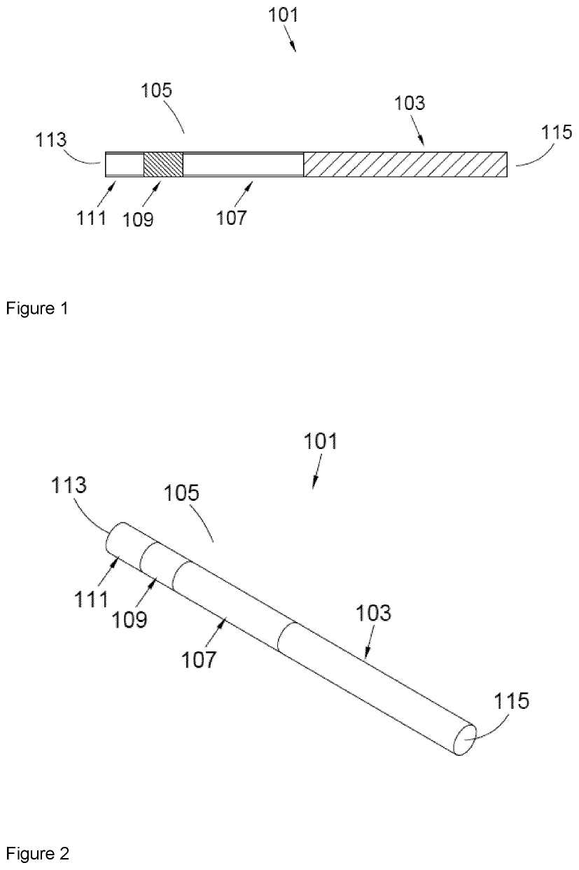

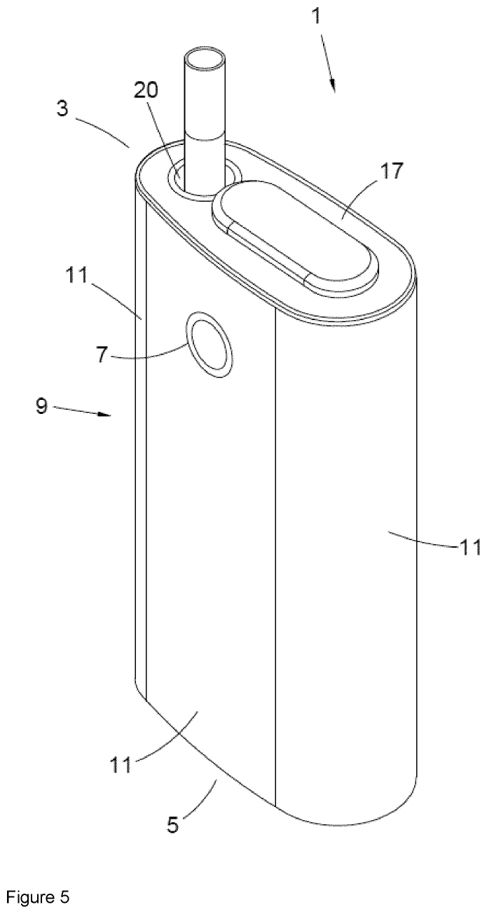

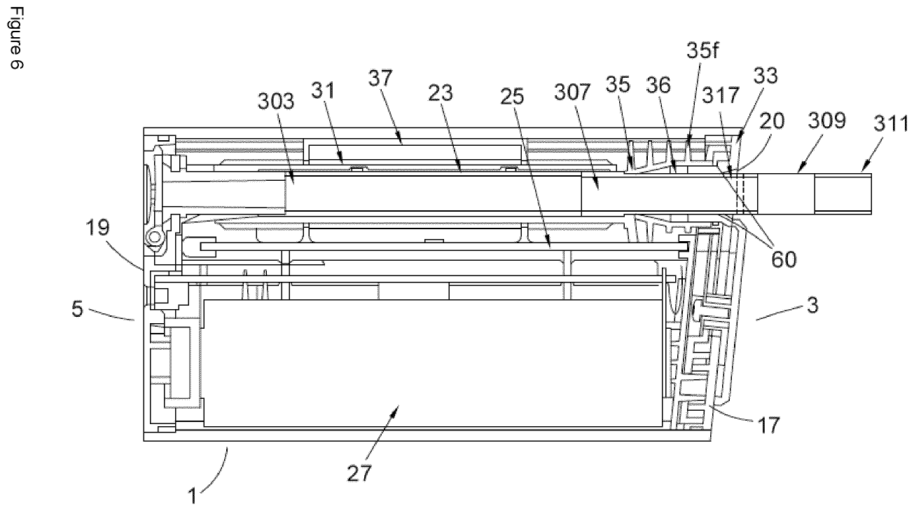

Referring to FIGS. 1 and 2, there are shown a partially cut-away section view and a perspective view of an example of an aerosol-generating article 101. The article 101 is adapted for use with a device having a power source and a heater. The article 101 of this embodiment is particularly suitable for use with the device 1 shown in FIGS. 5 to 7, described below. In use, the article 101 may be removably inserted into the device shown in FIG. 5 at an insertion point 20 of the device 1.

The article 101 of one example is in the form of a substantially cylindrical rod that includes a body of aerosol-generating composition 103 and a filter assembly 105 in the form of a rod. The aerosol-generating composition comprises the aerosol-generating material described herein.

The filter assembly 105 includes three segments, a cooling segment 107, a filter segment 109 and a mouth end segment 111. The article 101 has a first end 113, also known as a mouth end or a proximal end and a second end 115, also known as a distal end. The body of aerosol-generating composition 103 is located towards the distal end 115 of the article 101. In one example, the cooling segment 107 is located adjacent the body of aerosol-generating composition 103 between the body of aerosol-generating composition 103 and the filter segment 109, such that the cooling segment 107 is in an abutting relationship with the aerosol-generating composition 103 and the filter segment 103. In other examples, there may be a separation between the body of aerosol-generating composition 103 and the cooling segment 107 and between the body of aerosol-generating composition 103 and the filter segment 109. The filter segment 109 is located in between the cooling segment 107 and the mouth end segment 111. The mouth end segment 111 is located towards the proximal end 113 of the article 101, adjacent the filter segment 109. In one example, the filter segment 109 is in an abutting relationship with the mouth end segment 111. In some embodiments, the total length of the filter assembly 105 is between 37 mm and 45 mm, more preferably, the total length of the filter assembly 105 is 41 mm.

In one example, the rod of aerosol-generating composition 103 is between 34 mm and 50 mm in length, suitably between 38 mm and 46 mm in length, suitably 42 mm in length.

In one example, the total length of the article 101 is between 71 mm and 95 mm, suitably between 79 mm and 87 mm, suitably 83 mm.

An axial end of the body of aerosol-generating composition 103 is visible at the distal end 115 of the article 101. However, in other embodiments, the distal end 115 of the article 101 may comprise an end member (not shown) covering the axial end of the body of aerosol-generating composition 103.

The body of aerosol-generating composition 103 is joined to the filter assembly 105 by annular tipping paper (not shown), which is located substantially around the circumference of the filter assembly 105 to surround the filter assembly 105 and extends partially along the length of the body of aerosol-generating composition 103. In one example, the tipping paper is made of 58GSM standard tipping base paper. In one example the tipping paper has a length of between 42 mm and 50 mm, suitably of 46 mm.

In one example, the cooling segment 107 is an annular tube and is located around and defines an air gap within the cooling segment. The air gap provides a chamber for heated volatilised components generated from the body of aerosol-generating composition 103 to flow. The cooling segment 107 is hollow to provide a chamber for aerosol accumulation yet rigid enough to withstand axial compressive forces and bending moments that might arise during manufacture and whilst the article 101 is in use during insertion into the device 1. In one example, the thickness of the wall of the cooling segment 107 is approximately 0.29 mm.

The cooling segment 107 provides a physical displacement between the aerosol-generating composition 103 and the filter segment 109. The physical displacement provided by the cooling segment 107 will provide a thermal gradient across the length of the cooling segment 107. In one example the cooling segment 107 is configured to provide a temperature differential of at least 40 degrees Celsius between a heated volatilised component entering a first end of the cooling segment 107 and a heated volatilised component exiting a second end of the cooling segment 107. In one example the cooling segment 107 is configured to provide a temperature differential of at least 60 degrees Celsius between a heated volatilised component entering a first end of the cooling segment 107 and a heated volatilised component exiting a second end of the cooling segment 107. This temperature differential across the length of the cooling element 107 protects the temperature sensitive filter segment 109 from the high temperatures of the aerosol-generating composition 103 when it is heated by the device 1. If the physical displacement was not provided between the filter segment 109 and the body of aerosol-generating composition 103 and the heating elements of the device 1, then the temperature sensitive filter segment may 109 become damaged in use, so it would not perform its required functions as effectively.

In one example the length of the cooling segment 107 is at least 15 mm. In one example, the length of the cooling segment 107 is between 20 mm and 30 mm, more particularly 23 mm to 27 mm, more particularly 25 mm to 27 mm, suitably 25 mm.

The cooling segment 107 is made of paper, which means that it is comprised of a material that does not generate compounds of concern, for example, toxic compounds when in use adjacent to the heater of the device 1. In one example, the cooling segment 107 is manufactured from a spirally wound paper tube which provides a hollow internal chamber yet maintains mechanical rigidity. Spirally wound paper tubes are able to meet the tight dimensional accuracy requirements of high-speed manufacturing processes with respect to tube length, outer diameter, roundness and straightness.

In another example, the cooling segment 107 is a recess created from stiff plug wrap or tipping paper. The stiff plug wrap or tipping paper is manufactured to have a rigidity that is sufficient to withstand the axial compressive forces and bending moments that might arise during manufacture and whilst the article 101 is in use during insertion into the device 1.

The filter segment 109 may be formed of any filter material sufficient to remove one or more volatilised compounds from heated volatilised components from the aerosol-generating material. In one example the filter segment 109 is made of a mono-acetate material, such as cellulose acetate. The filter segment 109 provides cooling and irritation-reduction from the heated volatilised components without depleting the quantity of the heated volatilised components to an unsatisfactory level for a user.

In some embodiments, a capsule (not illustrated) may be provided in filter segment 109. It may be disposed substantially centrally in the filter segment 109, both across the filter segment 109 diameter and along the filter segment 109 length. In other cases, it may be offset in one or more dimension. The capsule may in some cases, where present, contain a volatile component such as a flavourant or aerosol generating agent.

The density of the cellulose acetate tow material of the filter segment 109 controls the pressure drop across the filter segment 109, which in turn controls the draw resistance of the article 101. Therefore the selection of the material of the filter segment 109 is important in controlling the resistance to draw of the article 101. In addition, the filter segment performs a filtration function in the article 101.

In one example, the filter segment 109 is made of a 8Y15 grade of filter tow material, which provides a filtration effect on the heated volatilised material, whilst also reducing the size of condensed aerosol droplets which result from the heated volatilised material.

The presence of the filter segment 109 provides an insulating effect by providing further cooling to the heated volatilised components that exit the cooling segment 107. This further cooling effect reduces the contact temperature of the user's lips on the surface of the filter segment 109.

In one example, the filter segment 109 is between 6 mm to 10 mm in length, suitably 8 mm.

The mouth end segment 111 is an annular tube and is located around and defines an air gap within the mouth end segment 111. The air gap provides a chamber for heated volatilised components that flow from the filter segment 109. The mouth end segment 111 is hollow to provide a chamber for aerosol accumulation yet rigid enough to withstand axial compressive forces and bending moments that might arise during manufacture and whilst the article is in use during insertion into the device 1. In one example, the thickness of the wall of the mouth end segment 111 is approximately 0.29 mm. In one example, the length of the mouth end segment 111 is between 6 mm to 10 mm, suitably 8 mm.

The mouth end segment 111 may be manufactured from a spirally wound paper tube which provides a hollow internal chamber yet maintains critical mechanical rigidity. Spirally wound paper tubes are able to meet the tight dimensional accuracy requirements of high-speed manufacturing processes with respect to tube length, outer diameter, roundness and straightness.

The mouth end segment 111 provides the function of preventing any liquid condensate that accumulates at the exit of the filter segment 109 from coming into direct contact with a user.

It should be appreciated that, in one example, the mouth end segment 111 and the cooling segment 107 may be formed of a single tube and the filter segment 109 is located within that tube separating the mouth end segment 111 and the cooling segment 107.

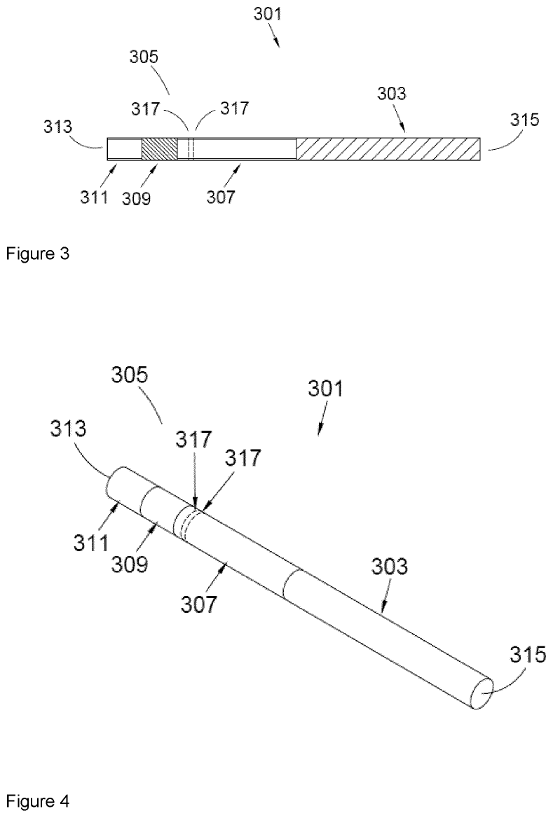

Referring to FIGS. 3 and 4, there are shown a partially cut-away section and perspective views of an example of an article 301. The reference signs shown in FIGS. 3 and 4 are equivalent to the reference signs shown in FIGS. 1 and 2, but with an increment of 200.

In the example of the article 301 shown in FIGS. 3 and 4, a ventilation region 317 is provided in the article 301 to enable air to flow into the interior of the article 301 from the exterior of the article 301. In one example the ventilation region 317 takes the form of one or more ventilation holes 317 formed through the outer layer of the article 301. The ventilation holes may be located in the cooling segment 307 to aid with the cooling of the article 301. In one example, the ventilation region 317 comprises one or more rows of holes, and preferably, each row of holes is arranged circumferentially around the article 301 in a cross-section that is substantially perpendicular to a longitudinal axis of the article 301.

In one example, there are between one to four rows of ventilation holes to provide ventilation for the article 301. Each row of ventilation holes may have between 12 to 36 ventilation holes 317. The ventilation holes 317 may, for example, be between 100 to 500 μm in diameter. In one example, an axial separation between rows of ventilation holes 317 is between 0.25 mm and 0.75 mm, suitably 0.5 mm.

In one example, the ventilation holes 317 are of uniform size. In another example, the ventilation holes 317 vary in size. The ventilation holes can be made using any suitable technique, for example, one or more of the following techniques: laser technology, mechanical perforation of the cooling segment 307 or pre-perforation of the cooling segment 307 before it is formed into the article 301. The ventilation holes 317 are positioned so as to provide effective cooling to the article 301.

In one example, the rows of ventilation holes 317 are located at least 11 mm from the proximal end 313 of the article, suitably between 17 mm and 20 mm from the proximal end 313 of the article 301. The location of the ventilation holes 317 is positioned such that user does not block the ventilation holes 317 when the article 301 is in use.

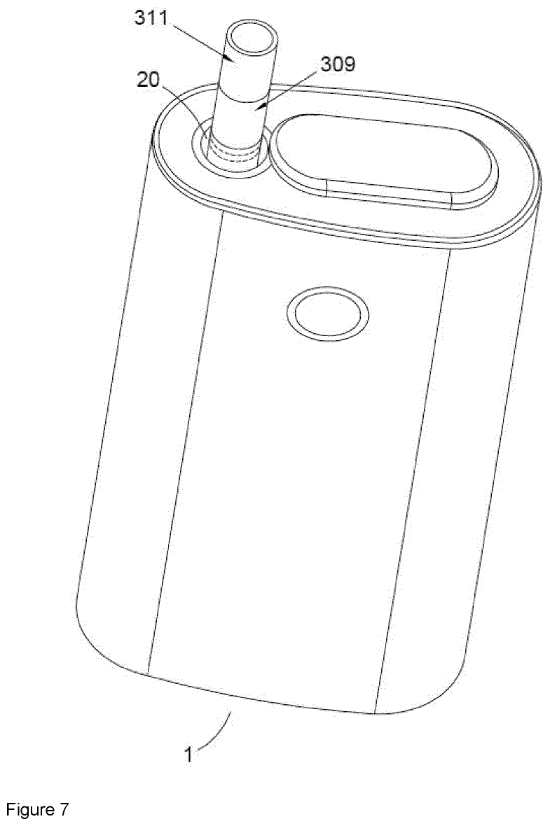

Providing the rows of ventilation holes between 17 mm and 20 mm from the proximal end 313 of the article 301 enables the ventilation holes 317 to be located outside of the device 1, when the article 301 is fully inserted in the device 1, as can be seen in FIGS. 6 and 7. By locating the ventilation holes outside of the device, non-heated air is able to enter the article 301 through the ventilation holes from outside the device 1 to aid with the cooling of the article 301.

The length of the cooling segment 307 is such that the cooling segment 307 will be partially inserted into the device 1, when the article 301 is fully inserted into the device 1. The length of the cooling segment 307 provides a first function of providing a physical gap between the heater arrangement of the device 1 and the heat sensitive filter arrangement 309, and a second function of enabling the ventilation holes 317 to be located in the cooling segment, whilst also being located outside of the device 1, when the article 301 is fully inserted into the device 1. As can be seen from FIGS. 6 and 7, the majority of the cooling element 307 is located within the device 1. However, there is a portion of the cooling element 307 that extends out of the device 1. It is in this portion of the cooling element 307 that extends out of the device 1 in which the ventilation holes 317 are located. Referring now to FIGS. 5 to 7 in more detail, there is shown an example of a device 1 arranged to heat aerosol-generating composition to volatilise at least one component of said aerosol-generating composition, typically to form an aerosol which can be inhaled. The device 1 is a heating device which releases compounds by heating, but not burning, the aerosol-generating composition.

A first end 3 is sometimes referred to herein as the mouth or proximal end 3 of the device 1 and a second end 5 is sometimes referred to herein as the distal end 5 of the device 1. The device 1 has an on/off button 7 to allow the device 1 as a whole to be switched on and off as desired by a user.

The device 1 comprises a housing 9 for locating and protecting various internal components of the device 1. In the example shown, the housing 9 comprises a uni-body sleeve 11 that encompasses the perimeter of the device 1, capped with a top panel 17 which defines generally the ‘top’ of the device 1 and a bottom panel 19 which defines generally the ‘bottom’ of the device 1. In another example the housing comprises a front panel, a rear panel and a pair of opposite side panels in addition to the top panel 17 and the bottom panel 19.

The top panel 17 and/or the bottom panel 19 may be removably fixed to the uni-body sleeve 11, to permit easy access to the interior of the device 1, or may be “permanently” fixed to the uni-body sleeve 11, for example to deter a user from accessing the interior of the device 1. In an example, the panels 17 and 19 are made of a plastics material, including for example glass-filled nylon formed by injection moulding, and the uni-body sleeve 11 is made of aluminium, though other materials and other manufacturing processes may be used.

The top panel 17 of the device 1 has an opening 20 at the mouth end 3 of the device 1 through which, in use, the article 101, 301 including the aerosol-generating composition may be inserted into the device 1 and removed from the device 1 by a user.

The housing 9 has located or fixed therein a heater arrangement 23, control circuitry 25 and a power source 27. In this example, the heater arrangement 23, the control circuitry 25 and the power source 27 are laterally adjacent (that is, adjacent when viewed from an end), with the control circuitry 25 being located generally between the heater arrangement 23 and the power source 27, though other locations are possible.

The control circuitry 25 may include a controller, such as a microprocessor arrangement, configured and arranged to control the heating of the aerosol-generating composition in the article 101, 301 as discussed further below.

The power source 27 may be for example a battery, which may be a rechargeable battery or a non-rechargeable battery. Examples of suitable batteries include for example a lithium-ion battery, a nickel battery (such as a nickel-cadmium battery), an alkaline battery and/or the like. The battery 27 is electrically coupled to the heater arrangement 23 to supply electrical power when required and under control of the control circuitry 25 to heat the aerosol-generating composition in the article (as discussed, to volatilise the aerosol-generating material without causing the aerosol-generating composition to burn).

An advantage of locating the power source 27 laterally adjacent to the heater arrangement 23 is that a physically large power source 25 may be used without causing the device 1 as a whole to be unduly lengthy. As will be understood, in general a physically large power source 25 has a higher capacity (that is, the total electrical energy that can be supplied, often measured in Amp-hours or the like) and thus the battery life for the device 1 can be longer.

In one example, the heater arrangement 23 is generally in the form of a hollow cylindrical tube, having a hollow interior heating chamber 29 into which the article 101, 301 comprising the aerosol-generating material is inserted for heating in use.

Different arrangements for the heater arrangement 23 are possible. For example, the heater arrangement 23 may comprise a single heating element or may be formed of plural heating elements aligned along the longitudinal axis of the heater arrangement 23. The or each heating element may be annular or tubular, or at least part-annular or part-tubular around its circumference. In an example, the or each heating element may be a thin film heater. In another example, the or each heating element may be made of a ceramics material. Examples of suitable ceramics materials include alumina and aluminium nitride and silicon nitride ceramics, which may be laminated and sintered. Other heating arrangements are possible, including for example inductive heating, infrared heater elements, which heat by emitting infrared radiation, or resistive heating elements formed by for example a resistive electrical winding.

In one particular example, the heater arrangement 23 is supported by a stainless steel support tube and comprises a polyimide heating element. The heater arrangement 23 is dimensioned so that substantially the whole of the body of aerosol-generating composition 103, 303 of the article 101, 301 is inserted into the heater arrangement 23 when the article 101, 301 is inserted into the device 1.

The or each heating element may be arranged so that selected zones of the aerosol-generating material can be independently heated, for example in turn (over time, as discussed above) or together (simultaneously) as desired.

The heater arrangement 23 in this example is surrounded along at least part of its length by a thermal insulator 31. The insulator 31 helps to reduce heat passing from the heater arrangement 23 to the exterior of the device 1. This helps to keep down the power requirements for the heater arrangement 23 as it reduces heat losses generally. The insulator 31 also helps to keep the exterior of the device 1 cool during operation of the heater arrangement 23. In one example, the insulator 31 may be a double-walled sleeve which provides a low pressure region between the two walls of the sleeve. That is, the insulator 31 may be for example a “vacuum” tube, i.e. a tube that has been at least partially evacuated so as to minimise heat transfer by conduction and/or convection. Other arrangements for the insulator 31 are possible, including using heat insulating materials, including for example a suitable foam-type material, in addition to or instead of a double-walled sleeve.

The housing 9 may further comprises various internal support structures 37 for supporting all internal components, as well as the heating arrangement 23.

The device 1 further comprises a collar 33 which extends around and projects from the opening 20 into the interior of the housing 9 and a generally tubular chamber 35 which is located between the collar 33 and one end of the vacuum sleeve 31. The chamber 35 further comprises a cooling structure 35f, which in this example, comprises a plurality of cooling fins 35f spaced apart along the outer surface of the chamber 35, and each arranged circumferentially around outer surface of the chamber 35. There is an air gap 36 between the hollow chamber 35 and the article 101, 301 when it is inserted in the device 1 over at least part of the length of the hollow chamber 35. The air gap 36 is around all of the circumference of the article 101, 301 over at least part of the cooling segment 307.

The collar 33 comprises a plurality of ridges 60 arranged circumferentially around the periphery of the opening 20 and which project into the opening 20. The ridges 60 take up space within the opening 20 such that the open span of the opening 20 at the locations of the ridges 60 is less than the open span of the opening 20 at the locations without the ridges 60. The ridges 60 are configured to engage with an article 101, 301 inserted into the device to assist in securing it within the device 1.

Open spaces (not shown in the Figures) defined by adjacent pairs of ridges 60 and the article 101, 301 form ventilation paths around the exterior of the article 101, 301. These ventilation paths allow hot vapours that have escaped from the article 101, 301 to exit the device 1 and allow cooling air to flow into the device 1 around the article 101, 301 in the air gap 36.

In operation, the article 101, 301 is removably inserted into an insertion point 20 of the device 1, as shown in FIGS. 5 to 7. Referring particularly to FIG. 6, in one example, the body of aerosol-generating composition 103, 303, which is located towards the distal end 115, 315 of the article 101, 301, is entirely received within the heater arrangement 23 of the device 1. The proximal end 113, 313 of the article 101, 301 extends from the device 1 and acts as a mouthpiece assembly for a user.

In operation, the heater arrangement 23 will heat the article 101, 301 to volatilise at least one component of the aerosol-generating composition from the body of aerosol-generating composition 103, 303.

The primary flow path for the heated volatilised components from the body of aerosol-generating composition 103, 303 is axially through the article 101, 301, through the chamber inside the cooling segment 107, 307, through the filter segment 109, 309, through the mouth end segment 111, 313 to the user. In one example, the temperature of the heated volatilised components that are generated from the body of aerosol-generating composition is between 60° C. and 250° C., which may be above the acceptable inhalation temperature for a user. As the heated volatilised component travels through the cooling segment 107, 307, it will cool and some volatilised components will condense on the inner surface of the cooling segment 107, 307.

In the examples of the article 301 shown in FIGS. 3 and 4, cool air will be able to enter the cooling segment 307 via the ventilation holes 317 formed in the cooling segment 307. This cool air will mix with the heated volatilised components to provide additional cooling to the heated volatilised components.

Another aspect of the invention provides a method of making an aerosol-generating material in the form of non-linear strands, such as the aerosol-generating material described herein.

The method may comprise:
(a) forming a mixture or slurry comprising a solvent, an aerosol-generating agent, a binder, optionally a filler, optionally a setting agent or crosslinking agent, and optionally an active and/or flavourant and/or an acid;
(b) casting the mixture or slurry in a mould.

Step (a) comprises forming a mixture or slurry comprising components of the aerosol-generating material or precursors thereof and a solvent (typically water). The slurry or mixture formed in step (a) may comprise a binder, an aerosol-generating agent, and optionally a filler, a setting or crosslinking agent, an active and/or a flavour and/or an acid. The mixture or slurry may comprise these components on a dry weight basis in any of the proportions given herein in relation to the composition of the aerosol-generating material.

Step (b) comprises casting the slurry in a mould. To form non-linear strands the mould must be a suitable shape. That is, the mould must be non-linear in shape. The skilled person would understand how materials may be formed using moulds, and would therefore understand the shape of mould needed to form a non-linear strand. Specifically, during a moulding process a slurry (which is flowable) is poured into or otherwise inserted into a mould, at which point it assumes the shape of the mould (or more specifically the mould cavity). After setting and/or drying the resulting material may be removed from the mould, or the mould may be removed from the material, and the resulting material will be in the shape of the mould.

By way of example, a strand having a spiral or helical shape could be formed using a mould having a spiral or helical shape, i.e. where the mould cavity has a spiral or helical shape. For such a shape, and for non-linear strands in general, it may be easier to remove the material from the mould if the mould is formed from two or more separable pieces or components. In this case, to assist removal of the material from the mould it is possible to separate the mould pieces or components.

As used herein, the term mould is used interchangeable with the term mould cavity.

In some embodiments the method is an injection moulding method. In this case, step (b) may comprise injection moulding the mixture or slurry. As discussed above, the mould may have a suitable shape to result in one or more non-linear strands. For example, the mould may be in a shape of a non-linear strand.

In some embodiments, the mould is in the shape of a net, a mesh or a mesh-like structure. Such a structure is essentially made up of multiple non-linear strands which are joined together in a grid-like system. The resulting net or mesh will therefore also be non-linear in shape. That is, each strand of the net or mesh is non-linear.

In some embodiments, the mould is in the shape of a net or mesh, wherein each strand of the net or mesh is non-linear. This may allow for the formation of an aerosol forming material in the form of a net or mesh, wherein each strand of the net or mesh is non-linear.

Alternatively, a net or mesh may be formed when non-linear strands are formed and then joined or woven together. The strands may be joined or woven together (e.g. into a grid formation) before, during and/or after drying. When being woven the strands may be dried before weaving. When being joined the strands may simply be placed on top of each other in the desired net, mesh or mesh-like shape, and the strands may then stick to each other. This may be done before, during or after drying.

As the slurry is cast in a mould, each non-linear strand or net, mesh or mesh-like structure produced by the method of the present invention will be uniform and possess the same parameters.

The process for forming the materials of the present invention may be advantageous compared to other methods of forming the materials because the moulding process allows for the formation of uniform strands and shapes. That is, the process is highly repeatable, and the strands and shapes formed from the process may all be identical or essentially identical, assuming the same mould or same shape mould is used each time. More generally, the shape, size, and other parameters of the strands or other shapes can be easily controlled by selecting the size and shape of the mould.

For example, the cross-section of the mould may determine the cross-section of the material which is formed by the method of the invention. In some embodiments the mould has a cylindrical cross-section. In this case, the cross-section of the final material will be circular or substantially circular.

In some embodiments, the mould has a diameter of from about 0.05 mm, 0.2 mm, 0.5 mm, 1.5 mm or 1.5 mm to about 4 mm, 3.0 mm, 2.5 mm or 1.5 mm. In some embodiments, the mould has a diameter of from about 0.05 to about 4 mm, from about 0.5 to about 4 mm, from about 1.0 to about 3.0 mm, or from about 1.5 to about 2.5 mm.

In some embodiments, the mould has a diameter of from about 0.05 mm, 0.1 mm, 0.2 mm or 0.3 mm to about 3.0 mm, 2.0 mm, 1.0 mm, or 0.7 mm. In some embodiments, the mould has a diameter of from about 0.05 to about 3.0 mm, from about 0.1 to about 2.0 mm, from about 0.2 to about 2.0 mm, or from about 0.3 to about 0.7 mm.

The method of the invention may further comprise:
(c) removing the aerosol-generating material from the mould; and
(d) drying the material.

Step (c) of removing the material from the mould may comprise manually removing the material from the mould. The mould may be separated and the material removed.

The process described hereby may be continuous or batch process, but is generally a continuous process.

The drying step (d) may comprise any suitable drying methods, including but not limited to, infrared (IR) heating, convention heating, air impingement, conductive heating and microwave heating. Conductive heating may comprise heating a surface on which the material is placed. The surface may be, for example, a metal or metal alloy (e.g. stainless steel) band. The surface may itself heat up (e.g. it is the surface of a heater) or be indirectly heated. For example, the surface may be heated from below, for example using steam. In some embodiments the drying step (d) is performed using a belt dryer.

The drying step (d) may, in some cases, remove from about 50 wt %, 60 wt %, 70 wt %, 80 wt % or 90 wt % to about 80 wt %, 90 wt % or 95 wt % (WWB) of water in the slurry.

Drying may be performed at suitable temperature, for example from room temperature (25° C.) to about 200° C., such as from about 50° C. to about 150° C. or from about 100° C. to about 130° C. As the skilled person would appreciate, higher temperatures may allow for faster drying times, but can be more energy intensive.

In some embodiments the material is dried for from about 30 seconds to about 10 minutes, such as from about 1 minute to about 5 minutes, such as from about 2 minutes to about 4 minutes.

The drying step (d) may, in some cases, reduce the average diameter of each of the strands by at least about 20%, such as between about 20% and about 90%, or between about 30% and about 70%.

During step (d) the material may be heated to remove at least about 60 wt %, 70 wt %, 80 wt %, 85 wt % or 90 wt % of the solvent, which is typically water.

Following drying step (d), the aerosol-generating material may have a water content as defined above. In particular, the aerosol-generating material may have of from 1 wt % to 15 wt % (WWB). Suitably, the water content of the aerosol-generating material may be from about 5 wt %, 7 wt % or 9 wt % to about 15 wt %, 13 wt %, 11 wt %, 9 wt % or 8 wt % (wet weight basis) (WWB). In some embodiments, the aerosol-generating material has a water content of less than about 9 wt % (WWB), such as less than about 8 wt % (WWB). The water content of the aerosol-generating material may, for example, be determined by Karl-Fischer-titration or Gas Chromatography with Thermal Conductivity Detector (GC-TCD).

In some cases, the solvent which is part of the slurry or mixture may consist essentially of or consist of water. In some cases, the slurry or mixture may comprise from about 50 wt %, 60 wt %, 70 wt %, 80 wt % or 90 wt % of solvent (WWB).

In cases where the solvent consists of water, the dry weight content of the slurry may match the dry weight content of the aerosol-generating material. Thus, the discussion herein relating to the solid material is explicitly disclosed in combination with the slurry aspect of the invention. In particular, aspects and embodiments above defining components of the aerosol-generating material and amounts thereof apply mutatis mutandis to the slurry of the invention and the method of the invention.

The drying step may be performed before, during or after the material is removed from the mould. In some embodiments, step (c) of removing the aerosol-generating material from the mould occurs after drying step (d).

The method of the invention may also comprise cutting the non-linear strands to a desired free length, after the material is removed from the mould. This step may occur before or after drying. The desired free length may be as set out hereinabove.

In some embodiments, the material is cut into a plurality of non-linear strands before drying step (d). Cutting the material into a plurality of non-linear strands (each shorter than the non-linear strand(s) initially formed) before drying the material can reduce tangling of the material, which can in turn make the material easier to process and/or incorporated into an article. Reducing tangling of the material may also make it easier to form a homogeneous mixture if the material is blended with tobacco.

In some embodiments, the non-linear strands may be arranged to form a net, mesh or mesh-like structure. In some embodiments, the non-linear strands may be joined or woven together to form sheets of aerosol-generating material. Such structures may be formed by arranging the strands into the shape of a net or mesh (e.g. a grid formation) before, during and/or after drying.

In a further aspect, the invention also provides an aerosol-generating material obtainable by, or obtained by a method of the invention. Aspects and embodiments above defining components of the aerosol-generating material and amounts thereof apply mutatis mutandis to this further aspect of the invention.

According to an aspect of the present invention there is provided a method of generating an aerosol using a non-combustible aerosol provision system as described herein. In some embodiments, the method comprises heating the aerosol-generating material (or the aerosol-generating composition) to a temperature of less than or equal to 350° C. In some embodiments, the method comprises heating the aerosol-generating material (or the aerosol-generating composition) to a temperature of from about 220° C. to about 280° C. In some embodiments, the method comprises heating at least a portion of the aerosol-generating material (or the aerosol-generating composition) to a temperature of from about 220° C. to about 280° C. over a session of use.

“Session of use” as used herein refers to a single period of use of the non-combustible aerosol provision system by a user. The session of use begins at the point at which power is first supplied to at least one heating unit present in the heating assembly. The device will be ready for use after a period of time has elapsed from the start of the session of use. The session of use ends at the point at which no power is supplied to any of the heating elements in the aerosol-generating device. The end of the session of use may coincide with the point at which the smoking article is depleted (the point at which the total particulate matter yield (mg) in each puff would be deemed unacceptably low by a user). The session will have a duration of a plurality of puffs. Said session may have a duration less than 7 minutes, or 6 minutes, or 5 minutes, or 4 minutes and 30 seconds, or 4 minutes, or 3 minutes and 30 seconds. In some embodiments, the session of use may have a duration of from 2 to 5 minutes, or from 3 to 4.5 minutes, or 3.5 to 4.5 minutes, or suitably 4 minutes. A session may be initiated by the user actuating a button or switch on the device, causing at least one heating element to begin rising in temperature.

All percentages by weight described herein (denoted wt %) are calculated on a dry weight basis (DWB), unless explicitly stated otherwise. All weight ratios are also calculated on a dry weight basis. A weight quoted on a dry weight basis refers to the whole of the slurry, aerosol-generating composition or aerosol-generating material, other than the water, and may include components which by themselves are liquid at room temperature and pressure, such as glycerol. Conversely, a weight percentage quoted on a wet weight basis (WWB) refers to all components, including water.

For the avoidance of doubt, where in this specification the term “comprises” is used in defining the invention or features of the invention, embodiments are also disclosed in which the invention or feature can be defined using the terms “consists essentially of” or “consists of” in place of “comprises”. Reference to a material “comprising” certain features means that those features are included in, contained in, or held within the material.

Any feature described in relation to one aspect of the invention is expressly disclosed in combination with any other aspect described herein.

### EXEMPLARY EMBODIMENTS

Further embodiments of the invention are as follows:
Embodiment 1. A moulded aerosol-generating material in the form of one or more non-linear strands, wherein the aerosol-generating material may comprise:
   an aerosol-generating agent; and/or
a binder.
Embodiment 2. The aerosol-generating material of any preceding embodiment, wherein each of the non-linear strands has a diameter of from about 0.05 mm to about 3 mm.
Embodiment 3. The aerosol-generating material of any preceding embodiment, wherein each of the non-linear strands has a diameter of from about 0.3 mm to about 2.5 mm.
Embodiment 4. The aerosol-generating material of any preceding embodiment, wherein each of the non-linear strands has a diameter of from about 0.5 to about 1.5 mm.
Embodiment 5. The aerosol-generating material of any preceding embodiment, wherein each of the non-linear strands has a diameter of from about 0.7 to about 1.1 mm.
Embodiment 5a. The aerosol-generating material of any preceding embodiment, wherein the non-linear strands are homogenous through the cross-section.
Embodiment 6. The aerosol-generating material of any preceding embodiment, wherein each of the non-linear strands has a thickness of from about 0.05 mm to about 3 mm.
Embodiment 7. The aerosol-generating material of any preceding embodiment, wherein each of the non-linear strands has a thickness of from about 0.3 mm to about 2.5 mm.
Embodiment 8. The aerosol-generating material of any preceding embodiment, wherein each of the non-linear strands has a thickness of from about 0.5 to about 1.5 mm.
Embodiment 9. The aerosol-generating material of any preceding embodiment, wherein each of the non-linear strands has a thickness of from about 0.7 to about 1.1 mm.
Embodiment 10. The aerosol-generating material of any preceding embodiment, wherein the ratio of the diameter to the thickness of each of the non-linear strands is from about 1:2 to about 2:1.
Embodiment 11. The aerosol-generating material of any preceding embodiment, wherein the ratio of the diameter to the thickness of each of the non-linear strands is from about 3:2 to about 2:3.
Embodiment 12. The aerosol-generating material of any preceding embodiment, wherein the ratio of the diameter to the thickness of each of the non-linear strands is about 1:1.
Embodiment 13. The aerosol-generating material of any preceding embodiment, wherein each of the non-linear strands has an uncoiled length of from about 8 mm to about 200 mm.
Embodiment 13a. The aerosol-generating material of any preceding embodiment, wherein each of the non-linear strands has an uncoiled length of from about 10 mm to about 200 mm.
Embodiment 14. The aerosol-generating material of any preceding embodiment, wherein each of the non-linear strands has an uncoiled length of from about 20 mm to about 100 mm.
Embodiment 15. The aerosol-generating material of any preceding embodiment, wherein each of the non-linear strands has an uncoiled length of from about 30 mm to about 50 mm.
Embodiment 16. The aerosol-generating material of any preceding embodiment, wherein each of the non-linear strands has a coiled length of from about 2 mm to about 35 mm.
Embodiment 17. The aerosol-generating material of any preceding embodiment, wherein each of the non-linear strands has a coiled length of from about 3 mm to about 25 mm.
Embodiment 18. The aerosol-generating material of any preceding embodiment, wherein each of the non-linear strands has a coiled length of from about 6 mm to about 23 mm.
Embodiment 19. The aerosol-generating material of any preceding embodiment, wherein each of the non-linear strands has a coiled length of from about 8 mm to about 22 mm.
Embodiment 20. The aerosol-generating material of any preceding embodiment, wherein each of the non-linear strands has a coiled length of from about 11 mm to about 20 mm.
Embodiment 21. The aerosol-generating material of any preceding embodiment, wherein the uncoiled length is greater than the coiled length.
Embodiment 22. The aerosol-generating material of any preceding embodiment, wherein the ratio between the uncoiled length and the coiled length of each non-linear strand is at least about 1.2.
Embodiment 23. The aerosol-generating material of any preceding embodiment, wherein the ratio between the uncoiled length and the coiled length of each non-linear strand is at least about 1.3.
Embodiment 24. The aerosol-generating material of any preceding embodiment, wherein the ratio between the uncoiled length and the coiled length of each non-linear strand is at least about 1.5.
Embodiment 25. The aerosol-generating material of any preceding embodiment, wherein the ratio between the uncoiled length and the coiled length of each non-linear strand is at least about 2.0.
Embodiment 25. The aerosol-generating material of any preceding embodiment, wherein the ratio between the uncoiled length and the coiled length of each non-linear strand is less than about 10.
Embodiment 26. The aerosol-generating material of any preceding embodiment, wherein the ratio between the uncoiled length and the coiled length of each non-linear strand is less than about 8.
Embodiment 27. The aerosol-generating material of any preceding embodiment, wherein the ratio between the uncoiled length and the coiled length of each non-linear strand is less than about 6.
Embodiment 28. The aerosol-generating material of any preceding embodiment, wherein the ratio between the uncoiled length and the coiled length of each non-linear strand is from about 1.2 to about 10.
Embodiment 29. The aerosol-generating material of any preceding embodiment, wherein the ratio between the uncoiled length and the coiled length of each non-linear strand is from about 1.5 to about 5.
Embodiment 30. The aerosol-generating material of any preceding embodiment, wherein the ratio between the uncoiled length and the coiled length of each non-linear strand is from about 2 to about 5.
Embodiment 31. The aerosol-generating material of any preceding embodiment, wherein the ratio between the uncoiled length and the diameter of each of the non-linear strands is from about 5 to about 200.
Embodiment 32. The aerosol-generating material of any preceding embodiment, wherein the ratio between the uncoiled length and the diameter of each of the non-linear strands is from about 10 to about 100.
Embodiment 33. The aerosol-generating material of any preceding embodiment, wherein the ratio between the uncoiled length and the diameter of each of the non-linear strands is from about 20 to about 50.
Embodiment 34. The aerosol-generating material of any preceding embodiment, wherein the tensile strength of each strand ranges from about 0.1 N to about 3.0 N.
Embodiment 35. The aerosol-generating material of any preceding embodiment, wherein the tensile strength of each strand ranges from about 0.2 N to about 2.0 N.
Embodiment 36. The aerosol-generating material of any preceding embodiment, wherein the tensile strength of each strand ranges from about 0.3 N to about 1.0 N.
Embodiment 37. The aerosol-generating material of any preceding embodiment, wherein the aerosol-generating material has a fill value of from about 2 cm³/g to about 7.5 cm³/g.
Embodiment 36. The aerosol-generating material of any preceding embodiment, wherein the aerosol-generating material has a fill value of from about 3 cm³/g to about 7 cm³/g.
Embodiment 36. The aerosol-generating material of any preceding embodiment, wherein the aerosol-generating material has a fill value of from about 3.5 cm³/g to about 6 cm³/g.
Embodiment 37. The aerosol-generating material of any preceding embodiment, wherein the aerosol-generating material has a fill value of from about 4 cm³/g to about 6 cm³/g.
Embodiment 37a. The aerosol-generating material of any preceding embodiment, wherein the aerosol-generating material has a fill value of from about 3 cm³/g to about 10 cm³/g.
Embodiment 37b. The aerosol-generating material of any preceding embodiment, wherein the aerosol-generating material has a fill value of from about 4 cm³/g to about 9.5 cm³/g.
Embodiment 37c. The aerosol-generating material of any preceding embodiment, wherein the aerosol-generating material has a fill value of from about 4.5 cm³/g to about 9 cm³/g.
Embodiment 37d. The aerosol-generating material of any preceding embodiment, wherein the aerosol-generating material has a fill value of from about 5 cm³/g to about 9 cm³/g.
Embodiment 38. The aerosol-generating material of any preceding embodiment, wherein the aerosol-generating material comprises from about 1 to about 80 wt % aerosol-generating agent.
Embodiment 39. The aerosol-generating material of any preceding embodiment, wherein the aerosol-generating material comprises from about 5 to about 60 wt % aerosol-generating agent.
Embodiment 40. The aerosol-generating material of any preceding embodiment, wherein the aerosol-generating material comprises from about 10 to about 50 wt % aerosol-generating agent.
Embodiment 41. The aerosol-generating material of any preceding embodiment, wherein the aerosol-generating material comprises from about 10 to about 45 wt % aerosol-generating agent.
Embodiment 42. The aerosol-generating material of any preceding embodiment, wherein the aerosol-generating material comprises from about 20 to about 40 wt % aerosol-generating agent.
Embodiment 43. The aerosol-generating material of any preceding embodiment, wherein the aerosol-generating material comprises from about 30 to about 40 wt % aerosol-generating agent.
Embodiment 44. The aerosol-generating material of any preceding embodiment, wherein the aerosol-generating agent comprises one or more of glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.
Embodiment 45. The aerosol-generating material of any preceding embodiment, wherein the aerosol-generating agent comprises glycerol.
Embodiment 46. The aerosol-generating material of any preceding embodiment, wherein the aerosol-generating material comprises from about 1 to about 60 wt % binder.
Embodiment 47. The aerosol-generating material of any preceding embodiment, wherein the aerosol-generating material comprises from about 5 to about 50 wt % binder.
Embodiment 48. The aerosol-generating material of any preceding embodiment, wherein the aerosol-generating material comprises from about 6 to about 40 wt % binder.
Embodiment 49. The aerosol-generating material of any preceding embodiment, wherein the aerosol-generating material comprises from about 7 to about 20 wt % binder.
Embodiment 50. The aerosol-generating material of any preceding embodiment, wherein the binder comprises crosslinked alginate and/or pectin.
Embodiment 50a. The aerosol-generating material of any preceding embodiment, wherein the binder comprises alginate and/or pectin and/or iota-carrageenan.
Embodiment 50b. The aerosol-generating material of any preceding embodiment, wherein the binder comprises alginate and/or iota-carrageenan.
Embodiment 51. The aerosol-generating material of any preceding embodiment, wherein the aerosol-generating material is substantially free of cellulosic binder.
Embodiment 52. The aerosol-generating material of any preceding embodiment, wherein the aerosol-generating material is substantially free of carboxymethylcellulose.
Embodiment 52a. The aerosol-generating material of any preceding embodiment, wherein the aerosol-generating material comprises a crosslinked binder and a non-crosslinked binder.
Embodiment 53. The aerosol-generating material of any preceding embodiment, wherein the aerosol-generating material comprises one or more fillers.
Embodiment 53a. The aerosol-generating material of any preceding embodiment, wherein the aerosol-generating material comprises from about 1 to about 60 wt % filler.
Embodiment 54. The aerosol-generating material of any preceding embodiment, wherein the aerosol-generating material comprises from about 1 to about 50 wt % filler.
Embodiment 55. The aerosol-generating material of any preceding embodiment, wherein the aerosol-generating material comprises from about 5 to about 45 wt % filler.
Embodiment 56. The aerosol-generating material of any preceding embodiment, wherein the aerosol-generating material comprises from about 10 to about 40 wt % filler.
Embodiment 57. The aerosol-generating material of any preceding embodiment, wherein the aerosol-generating material comprises from about 18 to about 35 wt % filler.
Embodiment 58. The aerosol-generating material of any preceding embodiment, wherein the aerosol-generating material comprises from about 20 to about 30 wt % filler.
Embodiment 58a. The aerosol-generating material of any preceding embodiment, wherein the aerosol-generating material comprises from about 10 to about 80 wt % filler.
Embodiment 58b. The aerosol-generating material of any preceding embodiment, wherein the aerosol-generating material comprises from about 20 to about 70 wt % filler.
Embodiment 58c. The aerosol-generating material of any preceding embodiment, wherein the aerosol-generating material comprises from about 30 to about 65 wt % filler.
Embodiment 58d. The aerosol-generating material of any preceding embodiment, wherein the aerosol-generating material comprises from about 40 to about 65 wt % filler.
Embodiment 59. The aerosol-generating material of any preceding embodiment, wherein the aerosol-generating material comprises less than about 60 wt % filler.
Embodiment 60. The aerosol-generating material of any preceding embodiment, wherein the aerosol-generating material comprises less than about 50 wt % filler.
Embodiment 61. The aerosol-generating material of any preceding embodiment, wherein the aerosol-generating material comprises less than about 30 wt % filler.
Embodiment 62. The aerosol-generating material of any preceding embodiment, wherein the aerosol-generating material comprises less than about 20 wt % filler.
Embodiment 63. The aerosol-generating material of any preceding embodiment, wherein the aerosol-generating material comprises less than about 10 wt % filler.
Embodiment 64. The aerosol-generating material of any preceding embodiment, wherein the filler is a fibrous organic filler material selected from wood pulp, hemp fibre, cellulose or cellulose derivatives, such as microcrystalline cellulose (MCC), nanocrystalline cellulose and/or ground cellulose.
Embodiment 65. The aerosol-generating material of any preceding embodiment, wherein the filler comprises wood pulp, MCC and/or ground cellulose.
Embodiment 65a. The aerosol-generating material of any preceding embodiment, wherein the aerosol-generating material has a water content of less than about 9 wt %.
Embodiment 65b. The aerosol-generating material of any preceding embodiment, wherein the aerosol-generating material has a water content of less than about 8 wt %.
Embodiment 66. The aerosol-generating material of any preceding embodiment, wherein the aerosol-generating material is substantially free from tobacco.
Embodiment 67. An aerosol-generating composition comprising the aerosol-generating material of any preceding embodiment.
Embodiment 68. The aerosol-generating composition of Embodiment 67 further comprising one or more additional active substances and/or flavours, and optionally one or more other functional materials.
Embodiment 69. The aerosol-generating composition of Embodiment 67 or 68 further comprising one or more other functional materials.
Embodiment 70. The aerosol-generating composition of Embodiment 68 or 69, wherein the other functional materials comprise one or more of pH regulators, colouring agents, preservatives, binders, fillers, stabilizers, and/or antioxidants.
Embodiment 71. The aerosol-generating composition of Embodiment 69, wherein the other functional materials comprise one or more fillers.
Embodiment 72. The aerosol-generating composition of Embodiment 71, wherein the fillers are selected from inorganic filler materials, wood pulp, hemp fibre, cellulose and cellulose derivatives.
Embodiment 73. The aerosol-generating composition of any of Embodiments 67-72, wherein the aerosol-generating composition comprises no calcium carbonate such as chalk.
Embodiment 74. The aerosol-generating composition of any of Embodiments 67-73, wherein the aerosol-generating composition does not comprise fibrous material.
Embodiment 75. The aerosol-generating composition of any of Embodiments 67-74, wherein the aerosol-generating composition does not comprise tobacco fibres.
Embodiment 76. The aerosol-generating composition of any of Embodiments 67-75, comprising from about 50-100 wt % (WWB) of the aerosol-generating material.
Embodiment 77. The aerosol-generating composition of any of Embodiments 67-76, comprising from about 50-95 wt % (WWB) of the aerosol-generating material.
Embodiment 78. The aerosol-generating composition of any of Embodiments 67-77, comprising from about 50-90 wt % (WWB) of the aerosol-generating material.
Embodiment 79. The aerosol-generating composition of any of Embodiments 67-78, comprising from about 60-100 wt % (WWB) of the aerosol-generating material.
Embodiment 80. The aerosol-generating composition of any of Embodiments 67-79, comprising from about 60-95 wt % (WWB) of the aerosol-generating material.
Embodiment 81. The aerosol-generating composition of any of Embodiments 67-80, comprising from about 60-90 wt % (WWB) of the aerosol-generating material.
Embodiment 82. The aerosol-generating composition of any of Embodiments 67-81, comprising from about 70-100 wt % (WWB) of the aerosol-generating material.
Embodiment 83. The aerosol-generating composition of any of Embodiments 67-82, comprising from about 70-95 wt % (WWB) of the aerosol-generating material.
Embodiment 84. The aerosol-generating composition of any of Embodiments 67-83, comprising from about 70-90 wt % (WWB) of the aerosol-generating material.
Embodiment 85. The aerosol-generating composition of any of Embodiments 67-84, consisting of, or consisting essentially of the aerosol-generating material.
Embodiment 85a. The aerosol-generating composition of any of Embodiments 67-85, wherein the aerosol-generating material is shredded and mixed with tobacco.
Embodiment 85b. The aerosol-generating composition of any of Embodiments 67-85, wherein the aerosol-generating composition comprises about 10-50 wt % aerosol-generating material and about 50-90 wt % tobacco.
Embodiment 85c. The aerosol-generating composition of any of Embodiments 67-85, wherein the aerosol-generating composition comprises about 20-40 wt % aerosol-generating material and about 60-80 wt % tobacco.
Embodiment 86. A consumable for use in a non-combustible aerosol provision device, the consumable comprising the aerosol-generating composition of any of Embodiments 67-85.
Embodiment 87. A non-combustible aerosol provision system comprising the consumable of Embodiment 86 and a non-combustible aerosol provision device.
Embodiment 88. The consumable for use in a non-combustible aerosol provision device of Embodiment 86, or the non-combustible aerosol provision system of Embodiment 87, wherein the non-combustible aerosol provision device is a heat-not-burn device.
Embodiment 88. A method of making the aerosol-generating material of any of Embodiments 1-66, the method comprising:
(a) forming a mixture or slurry comprising
   an aerosol-generating agent;
   a binder;
   optionally a filler;
   optionally a setting agent or crosslinking agent;
   optionally an active and/or flavourant and/or an acid; and
   a solvent;
(b) casting the mixture of slurry in a mould.
Embodiment 89. The method of Embodiment 88, wherein the mould has a suitable shape to result in one or more non-linear strands.
Embodiment 89a. The method of Embodiment 88, wherein the mould is in the shape of one or more non-linear strands.
Embodiment 90. The method of any of Embodiments 88-89, wherein the mould is in the shape of a mesh or mesh-like structure.
Embodiment 91. The method of any of Embodiments 88-90, wherein the mould is in the shape of a mesh, wherein each strand of the mesh is non-linear.
Embodiment 92. The method of any of Embodiments 88-91, further comprising: (c) removing the aerosol-generating material from the mould.
Embodiment 93. The method of Embodiment 92, further comprising:
(d) drying the material
Embodiment 93a. The method of Embodiment 93, where the drying occurs before removing the aerosol-generating material from the mould.
Embodiment 93b. The method of Embodiment 93, where the drying occurs after removing the aerosol-generating material from the mould.
Embodiment 93c. The method of Embodiment 93-93b, wherein the drying step (d) is performed using a belt dryer.
Embodiment 94. The method according to any of Embodiments 88-93, wherein the solvent is water.
Embodiment 95. An aerosol-generating material obtainable by the method of any of claims Embodiments 88-94.

1. A moulded aerosol-generating material in the form of one or more non-linear strands.

2. The aerosol-generating material of claim 1, wherein the aerosol-generating material comprises:
an aerosol-generating agent;
a binder;
optionally a setting agent;
optionally one or more fillers; and
optionally an active and/or a flavourant and/or an acid.

3. The aerosol-generating material of claim 1, wherein the non-linear strands are arranged to form a mesh or mesh-like structure.

4. The aerosol-generating material of claim 1, wherein each of the non-linear strands has a diameter of from about 0.05 mm to about 3 mm.

5. The aerosol-generating material of claim 1, wherein each of the non-linear strands has a thickness of from about 0.05 mm to about 3 mm.

6. The aerosol-generating material of claim 1, wherein the ratio of the diameter to the thickness of each of the non-linear strands is from about 1:2 to about 2:1.

7. The aerosol-generating material of claim 1, wherein each of the non-linear strands has an uncoiled length of from about 20 mm to about 100 mm; and/or wherein each of the non-linear strands has a coiled length of from about 3 mm to about 25 mm, provided that the uncoiled length is greater than the coiled length.

8. The aerosol-generating material of claim 1, wherein the ratio between the uncoiled length and the coiled length of each non-linear strand is at least about 1.2.

9. The aerosol-generating material of claim 1, wherein the ratio between the uncoiled length and the diameter of each of the non-linear strands is from about 5 to about 200.

10. The aerosol-generating material of claim 1, wherein the tensile strength of each strand ranges from about 0.1 N to about 3.0 N.

11. The aerosol-generating material of claim 1, wherein the aerosol-generating material has a fill value of from about 3 cm³/g to about 10 cm³/g.

12. (canceled)

13. (canceled)

14. (canceled)

15. The aerosol-generating material of claim 1, wherein the binder comprises alginate, pectin, starch or a derivative thereof, cellulose or a derivative thereof, carrageenan or gellan gum.

16. (canceled)

17. (canceled)

18. The aerosol-generating material of claim 1, wherein the aerosol-generating material further comprises a crosslinking agent.

19. The aerosol-generating material of claim 1, wherein the aerosol-generating material is substantially free from tobacco.

20. An aerosol-generating composition comprising the aerosol-generating material of claim 1.

21. (canceled)

22. (canceled)

23. (canceled)

24. (canceled)

25. A consumable for use with a non-combustible aerosol provision device, the consumable comprising the aerosol-generating composition according to claim 20.

26. A non-combustible aerosol provision system comprising the consumable according to claim 25 and a non-combustible aerosol provision device, wherein the non-combustible aerosol provision device is configured to generate aerosol from the consumable when the consumable is used with the non-combustible aerosol provision device.

27. (canceled)

28. (canceled)

29. A method of making the aerosol-generating material of claim 1, the method comprising:
(a) forming a mixture comprising
an aerosol-generating agent;
a binder;
optionally a setting agent;
optionally a filler;
optionally an active and/or flavourant and/or an acid; and
a solvent;
(b) casting the slurry into a mould.

30. The method of claim 29, wherein the mould is in the form of non-linear strands.

31. (canceled)

32. An aerosol-generating material obtainable by the method of claim 29.
